(19) United States
(12) Patent Application Publication
(10) Pub. No.: US 2026/0075338 A1
(43) Pub. Date: Mar. 12, 2026

(54) IMAGE SENSOR DEVICE

(71) Applicant: SAMSUNG ELECTRONICS CO., LTD., Suwon-si (KR)

(72) Inventors: Jinkyeong Heo, Suwon-si (KR); Donghyun Kim, Suwon-si (KR); Serin Kim, Suwon-si (KR)

(73) Assignee: SAMSUNG ELECTRONICS CO., LTD., Suwon-si (KR)

(21) Appl. No.: 19/081,619

(22) Filed: Mar. 17, 2025

(30) Foreign Application Priority Data
Sep. 12, 2024 (KR) 10-2024-0124802
Oct. 4, 2024 (KR) 10-2024-0134877

(51) Int. Cl. H04N 25/78; H04N 25/51; H04N 25/53

(52) U.S. Cl. CPC H04N 25/78; H04N 25/51; H04N 25/53

(57) ABSTRACT

An image sensor device includes a sensor and a processor. The sensor includes a plurality of pixels, and a peripheral circuit that executes execute a first shutter operation, a first exposure operation, a first readout operation, a second shutter operation, a second exposure operation and a second readout operation in sequence for the plurality of pixels. The processor includes a signal processor that obtains main data by processing a first pixel signal obtained by the first readout operation, and obtain sub-data by processing a second pixel signal obtained by the second readout operation, and an interface circuit that alternately transmits at least a portion of a plurality of main line data included in the main data and at least a portion of a plurality of sub-line data included in the sub-data.

### CROSS-REFERENCE TO RELATED APPLICATION(S)

This application is based on and claims benefit of priority to Korean Patent Application No. 10-2024-0134877 filed on Oct. 4, 2024, and Korean Patent Application No. 10-2024-0124802 filed on Sep. 12, 2024, in the Korean Intellectual Property Office, the disclosures of which are incorporated herein by reference in their entirety.

### BACKGROUND

### 1. Field

Example embodiments of the disclosure relate to an image sensor device.

### 2. Description of Related Art

An image capturing device (e.g., a camera) may be configured to receive light and generate image data. The image capturing device may include an image sensor including a plurality of pixels configured to generate electric signals in response to light, a peripheral circuit configured to drive the plurality of pixels to generate raw data, and a signal processor configured to generate image data by processing the raw data. Recently, image capturing devices (also referred to as image sensor device) are implemented in fields such as a vehicle, methods for accurately imaging various types of subjects have been researched. As one of the methods, various subjects may be accurately photographed by driving a plurality of image sensors differently, but this method may require a great deal of space and may increase power consumption and price. Accordingly, various methods for accurately imaging various subjects having different characteristics by a single image sensor is being researched.

### SUMMARY

Aspects of the disclosure relate to an improved image sensor device which may accurately image (or capture images of) various types of subjects by improving dynamic range, signal-to-noise ratio, frame rate, or the like.

According to an aspect of the disclosure, there is provided an image sensor device, including: a sensor including a plurality of pixels, and a peripheral circuit configured to drive the plurality of pixels; and a processor including a signal processor configured to obtain image data by processing a pixel signal output by the peripheral circuit, and an interface circuit configured to transmit the image data to an external device, wherein each of the plurality of pixels includes a first photodiode having a first light-receiving area, a second photodiode having a second light-receiving area smaller than the first light-receiving area, and a pixel circuit connecting the first photodiode and the second photodiode to the peripheral circuit, wherein the peripheral circuit is further configured to obtain a first pixel signal by executing a first readout operation for the plurality of pixels after a first exposure time, and obtain a second pixel signal by executing a second readout operation different from the first readout operation for at least a portion of pixels among the plurality of pixels after a second exposure time shorter than the first exposure time, wherein the signal processor is further configured to obtain first data by processing the first pixel signal and obtain second data by processing the second pixel signal, and wherein the interface circuit is configured to start transmission of the second data before transmission of the first data is completed.

According to another aspect of the disclosure, there is provided an image sensor device, including: a plurality of pixels arranged along a plurality of row lines and a plurality of column lines, each of the plurality of pixels comprising a first photodiode having a first light-receiving area, a second photodiode having a second light-receiving area smaller than the first light-receiving area, and a pixel circuit connected to the first photodiode and the second photodiode; a peripheral circuit configured to execute a first shutter operation, a first exposure operation for a first time, a first readout operation, a second shutter operation, a second exposure operation for a second time shorter than the first time, and a second readout operation for the plurality of pixels in sequence; and a signal processor configured to obtain image data by processing a pixel signal output by the peripheral circuit, wherein the peripheral circuit, while executing the first readout operation for each of first pixels arranged along a first row line among the plurality of row lines, is further configured to execute the second shutter operation for the first photodiode and the second photodiode included in each of second pixels arranged along a second row line different from the first row line.

According to another aspect of the disclosure, there is provided an image sensor device, including: a sensor including a plurality of pixels, and a peripheral circuit configured to execute a first shutter operation, a first exposure operation, a first readout operation, a second shutter operation, a second exposure operation and a second readout operation in sequence for the plurality of pixels; and a processor including: a signal processor configured to obtain first data by processing a first pixel signal obtained by the first readout operation by the peripheral circuit, and obtain second data by processing a second pixel signal obtained by the second readout operation by the peripheral circuit, and an interface circuit configured to transmit the first data and the second data to an external device, wherein the first data has a first resolution and the second data has a second resolution lower than the first resolution, and wherein the interface circuit is further configured to alternately transmit at least a portion of a plurality of first line data included in the first data and at least a portion of a plurality of second line data included in the second data.

### BRIEF DESCRIPTION OF DRAWINGS

The above and other aspects, features, and advantages of the disclosure will be more clearly understood from the following detailed description, taken in combination with the accompanying drawings, in which:

FIG. 1 is a block diagram illustrating an image sensor device according to an example embodiment of the disclosure;

FIGS. 2 and 3 are diagrams illustrating a pixel array structure included in an image sensor device according to an example embodiment of the disclosure;

FIG. 4 is a circuit diagram illustrating a pixel included in an image sensor device according to an example embodiment of the disclosure;

FIG. 5 is a diagram illustrating operations of an image sensor device according to an example embodiment of the disclosure;

FIGS. 6 to 12 are diagrams illustrating operations of an image sensor device according to an example embodiment of the disclosure;

FIGS. 13 and 14 are diagrams illustrating a readout operation of an image sensor device according to an example embodiment of the disclosure;

FIGS. 15 and 16 are diagrams illustrating operations of an interface circuit included in an image sensor device according to an example embodiment of the disclosure;

FIG. 17 is a diagram illustrating a readout operation of an image sensor device according to an example embodiment of the disclosure;

FIGS. 18 and 19 are diagrams illustrating operations of an interface circuit included in an image sensor device according to an example embodiment of the disclosure;

FIG. 20 is a diagram illustrating operations of an image sensor device according to an example embodiment of the disclosure;

FIGS. 21 and 22 are diagrams illustrating a readout operation of an image sensor device according to an example embodiment of the disclosure;

FIG. 23 is a diagram illustrating operations of an image sensor device according to an example embodiment of the disclosure;

FIGS. 24 and 25 are diagrams illustrating a readout operation of an image sensor device according to an example embodiment of the disclosure;

FIGS. 26 and 27 are diagrams illustrating operations of an interface circuit included in an image sensor device according to an example embodiment of the disclosure;

FIG. 28 is a diagram illustrating operations of an image sensor device according to an example embodiment of the disclosure;

FIG. 29 is a diagram illustrating a readout operation of an image sensor device according to an example embodiment of the disclosure;

FIG. 30 is a diagram illustrating operations of an interface circuit included in an image sensor device according to an example embodiment of the disclosure;

FIGS. 31 and 32 are diagrams illustrating operations of an image sensor device according to an example embodiment of the disclosure; and

FIGS. 33 to 35 are diagrams illustrating operations of an image sensor device according to an example embodiment of the disclosure.

### DETAILED DESCRIPTION

Hereinafter, embodiments of the disclosure will be described as follows with reference to the accompanying drawings.

As used herein, an expression “at least one of” preceding a list of elements modifies the entire list of the elements and does not modify the individual elements of the list. For example, an expression, “at least one of a, b, and c” should be understood as including only a, only b, only c, both a and b, both a and c, both b and c, or all of a, b, and c.

The embodiments of the disclosure are example embodiments, and thus, the disclosure is not limited thereto, and may be realized in various other forms. As is traditional in the field, embodiments may be described and illustrated in terms of blocks, as shown in the drawings, which carry out a described function or functions. These blocks, which may be referred to herein as units or modules or the like, or by names such as device, logic, circuit, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

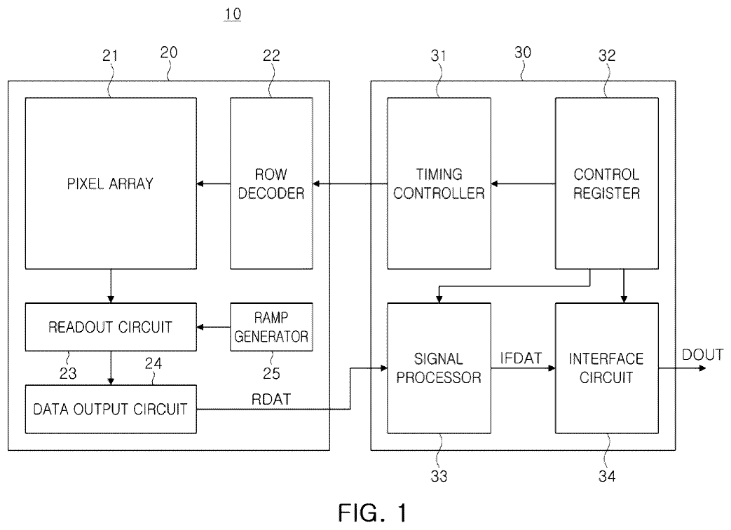

FIG. 1 is a block diagram illustrating an image sensor according to an example embodiment.

Referring to FIG. 1, an electronic device 10 may include an image sensor 20 and a processor 30. The electronic device may be referred to as an image capturing device or an image sensor device. The image sensor 20 may include a pixel array 21 and one or more peripheral circuits. The processor 30 may include a timing controller 31, a control register 32, a signal processor 33, and an interface circuit 34. However, the disclosure is not limited thereto, and as such, according to an embodiment, the image sensor 20 and the signal processor 30 may include one or more additional components, omit one or more components, or one or more components may be combined. The pixel array 21 may include a plurality of pixel regions provided in an array form. For example, plurality of pixel regions may be arranged along a plurality of rows and a plurality of columns. Each of the plurality of pixel regions may include a photoelectric conversion element configured to generate electric charge based on (or in response to) light, and the photoelectric conversion element may be connected to a pixel circuit configured to generate and output an electric signal corresponding to the electric charge generated by the photoelectric conversion element.

A pixel may be implemented by the photoelectric conversion element and the pixel circuit. The photoelectric conversion element may include a photodiode formed of a semiconductor material, and/or an organic photodiode formed of an organic material. In an example embodiment, a pixel may include a first photodiode and a second photodiode having different light-receiving areas.

For example, the pixel circuit may include a plurality of transistors and capacitors. The capacitor may store electric charge generated excessively in the photodiode and may be connected to the photodiode through at least one transistor. In an example embodiment, the capacitor may include, but is not limited to, a metal-insulator-metal (MIM) capacitor.

The one or more peripheral circuits may include circuits for controlling the pixel array 21. For example, the one or more peripheral circuits may include a row decoder 22, a readout circuit 23, a data output circuit 24, a ramp generator 25. The one or more peripheral circuits may operate based on (or in response to) a command, for example, a timing signal, transferred by a timing controller 31 of the signal processor 30. The row decoder 22 may drive the pixel array 21 as a row lines unit. For example, the row decoder 22 may input control signals for controlling turning on/off of each transistor included in the pixel circuit to the pixel array 21 as a row line unit.

Among the pixels in the pixel array 21, pixels provided at the same position in the row direction (for example, the horizontal direction in FIG. 1) may share the same column line. For example, pixels provided at the same position in the column direction (the vertical direction in FIG. 1) may be simultaneously selected by the row decoder 22 and may output voltage signals through the column lines. In an example embodiment, the readout circuit 23 may simultaneously receive signals from two or more pixels selected by the row decoder 22 through the column lines. For example, the readout circuit 23 may read the reset voltage and the signal voltage from each pixel, and the signal voltage may be obtained by reflecting the electric charge generated by the photodiode of each pixel in a reset voltage.

The readout circuit 23 may include a plurality of correlated dual samplers and a plurality of counters, and the correlated dual samplers may be connected to pixels through column lines. For example, a correlated dual sampler and a counter may be connected to a column line. The correlated dual samplers may read voltages from pixels connected to the row line selected by the row decoder 22 through the column lines. According to an embodiment, each of the correlated dual samplers may include, but is not limited to, a first input terminal, a second input terminal, and an output terminal. For example, the first input terminals of the correlated dual samplers may be connected to the column lines, and the second input terminals of the correlated dual samplers may receive a ramp voltage from the ramp generator 25.

The output terminal of each of the correlated dual samplers may be connected to the counters. The counters may generate a digital pixel signal by counting the time during which an output of each of the correlated dual samplers is maintained at a specific voltage. For example, the counters may convert an output of the correlated dual sampler into a digital pixel signal by counting the time during which the ramp voltage input to the correlated dual sampler is greater than the voltage of the column line. The data output circuit 24 may include a memory such as a latch and a buffer circuit configured to temporarily store a digital pixel signal, and may output a raw data RDAT including a digital pixel signal to a signal processor 30.

According to an embodiment, one or more operations of the image sensor 20 may be controlled by the timing controller 31 of the processor 30. The timing controller 31 may control a timing of the one or more operations of the sensor unit 20 based on (or in response to) a command received from the controller register 32. The signal processor 33 may receive raw data RDAT from the data output circuit 24 and may generate an image data IFDAT using the raw data RDAT.

For example, the image data IFDAT generated by the signal processor 33 may include a plurality of image frames having a frame rate. The frame rate may be predetermined frame rate. The interface circuit 34 may transmit output data DOUT including the image data IFDAT to an external device using a protocol. The protocol may be a predetermined protocol. For example, the protocol may include, but is not limited to, a mobile industry processor interface (MIPI).

In an example embodiment, the readout circuit 23 may execute a readout operation for each of the plurality of pixels two or more times. In an example case in which one row line among the plurality of row lines is selected, the readout circuit 23 may read a signal corresponding to electric charge generated by exposure of pixels arranged along the selected row line to light. In an example embodiment, the readout circuit 23 may read a signal corresponding to electric charge generated by pixels during an exposure time multiple times.

The readout circuit 23 may obtain signals from pixels under different operation conditions. For example, the readout circuit 23 may execute at least one readout operation under conditions in which each pixel has a large conversion gain and a small conversion gain. The conversion gain of each pixel may be varied depending on turning on/off of the transistor connected to the floating diffusion node of each pixel.

In an example embodiment, the readout circuit 23 may execute a first readout operation after a first exposure time, and may execute a second readout operation after a second exposure time shorter than the first exposure time. The first readout operation and the second readout operation may be executed with the same scheme or with different schemes. For example, the signal processor 33 may generate main data by processing the first pixel signal output by the first readout operation, and may generate sub-data by process the second pixel signal output by the second readout operation. The sub-data may have capacity smaller than capacity of the main data. According to various embodiments, the main data may be referred to as “first data”, “primary data”, “first readout data”, etc., and the sub-data data may be referred to as “second data”, “secondary data”, “second readout data”, etc.

In an example embodiment, the signal processor 33 may generate an image data IFDAT in which main data and sub-data are included in one frame. In the image data IFDAT, the main data and sub-data may be included in one frame. The main data may include a plurality of pieces of main line data, and the sub-data may include a plurality of pieces of sub-line data, and in an example embodiment, the number of the plurality of pieces of main line data may be greater than the number of the plurality of pieces of sub-line data.

The interface circuit 34 may transmit the output data DOUT including the image data IFDAT to an external device. In an example embodiment, the interface circuit 34 may transmit the entirety of the plurality of pieces of main line data included in the main data, and may transmit the plurality of pieces of sub-line data included in the sub-data. In order for the main data and sub-data to be included in one frame, packets indicating the start and end of the frame may not be included between the main data and the sub-data.

In an example embodiment, the interface circuit 34 may alternately output at least a portion of the plurality of pieces of main line data and at least a portion of the plurality of pieces of sub-line data. The interface circuit 34 may output the plurality of pieces of main line data and the plurality of pieces of sub-line data in synchronization with a predetermined horizontal period. For example, the interface circuit 34 may output the image data IFDAT differently in at least a portion of a plurality of horizontal periods.

The main data may be an image executed by obtaining by a setting of a relatively long first exposure time, and the sub-data may be an image executed by obtaining by a setting of a relatively short second exposure time. For example, the first exposure time may be longer than the second exposure time. For example, the first exposure time may be greater than a reference value and the second exposure time may be lesser than the reference value. For example, the first exposure time may be greater than a first reference value and the second exposure time may be lesser than a second reference value, the second reference value being smaller than the first reference value. Various types of subjects may be accurately obtained and recognized using the main data and the sub-data generated by the electronic device 10. In an example case in which the electronic device 10 is mounted on a vehicle such as an automobile, a subject having flicker characteristics may be accurately recognized using main data, and the position and the shape of a fast-moving subject may be accurately recognized using sub-data.

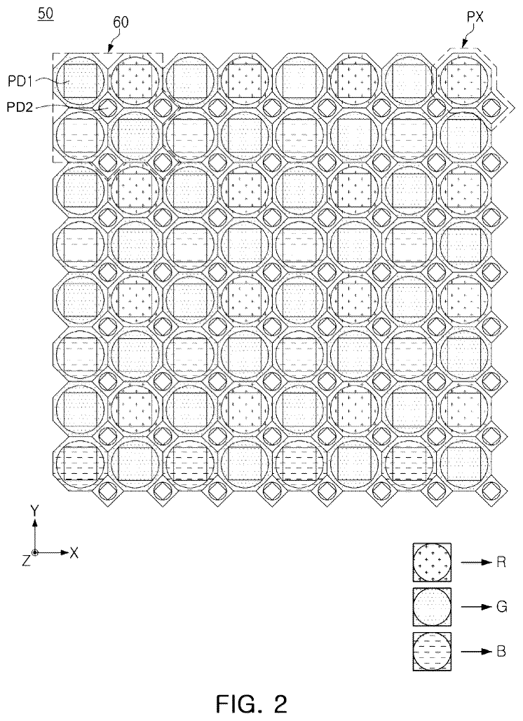

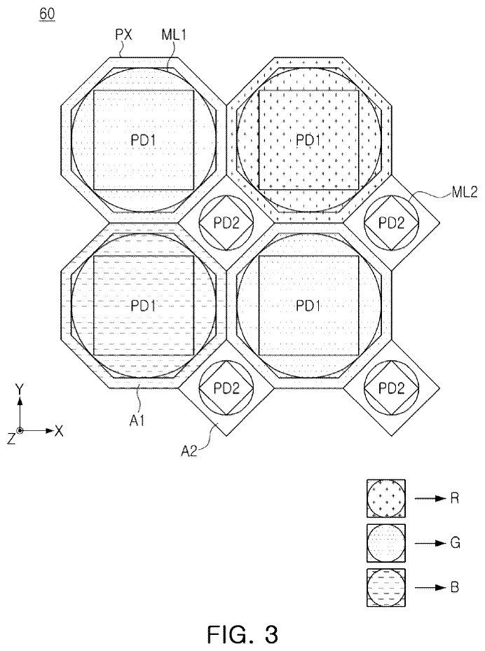

FIGS. 2 and 3 are diagrams illustrating a pixel array structure included in an image sensor device according to an example embodiment.

Referring to FIG. 2, a pixel array 50 may include a plurality of pixels PX arranged in the first direction (X-axis direction) and the second direction (Y-axis direction). Each of the plurality of pixels PX may include a first photodiode PD1 and a second photodiode PD2, and a light-receiving area of the first photodiode PD1 may be larger than a light-receiving area of the second photodiode PD2. In the example embodiment illustrated in FIG. 2, in each of the plurality of pixels PX, the first photodiode PD1 and the second photodiode PD2 may be arranged in a diagonal direction intersecting the first direction and the second direction. However, the disclosure is not limited thereto, and as such, the first photodiode PD1 and the second photodiode PD2 may be a different arrangement.

Each of the plurality of pixels PX may include a color filter, and the color filter may transmit light corresponding to a wavelength of one of red, green, and blue colors. Each of the plurality of pixels PX may include one of a red color filter, a green color filter, and a blue color filter. In example embodiments, a portion of the plurality of pixels PX may include a color filter configured to transmit red, green, blue, and other colors of light, or may not include a color filter.

FIG. 3 may be an enlarged diagram illustrating a portion of region 60 in FIG. 2. Referring to FIG. 3, among the plurality of pixels PX, four pixels PX provided in a 2×2 form may be provided in a Bayer pattern. As illustrated in FIG. 3, among the four pixels PX provided in a 2×2 form, each of two pixels PX arranged diagonally may include a green color filter, and the other two pixels PX each may include a red color filter and a blue color filter.

In the example embodiment illustrated in FIGS. 2 and 3, each of the plurality of pixels PX may include a first microlens ML1 and a second microlens ML2. The first microlens ML1 may be provided on the first photodiode PD1 in the first light-receiving region A1, and the second microlens ML2 may be provided on the second photodiode PD2 in the second light-receiving region A2.

However, arrangement of the plurality of pixels PX may not be limited to the example illustrated in FIGS. 2 and 3. For example, the plurality of pixels PX may be provided in a tetra pattern in which four pixels PX provided in a 2×2 form in the first and second directions include color filters of the same color. Also, a portion of the plurality of pixels PX may not include a color filter, or may include a color filter configured to transmit red, green, and blue light and other color light.

In each of the plurality of pixels PX, the first photodiode PD1 and the second photodiode PD2 may be connected to a column line through a pixel circuit. The pixel circuit may include a plurality of transistors and capacitors. During the exposure time, the electric charge generated by exceeding the full well capacity (FWC) of the first photodiode PD1 and the second photodiode PD2 may be transferred to the capacitor and may be stored.

In an example case in which the image sensor device is mounted on a vehicle such as an automobile, the exposure time may be determined to be a predetermined time or longer to accurately recognize a flickering light source. However, when the exposure time is determined to be relatively long as above, other subjects may not be accurately obtained. For example, the shape of the subject may be distorted in an image of a subject moving at a high speed.

In an example embodiment, to address the above issue and/or other issues, the image sensor device may be configured to obtain main data as a pixel signal corresponding to electric charge generated by a first exposure time, and obtain sub-data as a pixel signal corresponding to electric charge generated by a second exposure time shorter than the first exposure time. As such, even in an example case in which the image sensor device is mounted on a vehicle, a flickering light source may be accurately obtained using the main data, and other subjects may be imaged or obtained without distortion using the sub-data.

The main data and the sub-data may be included in one frame. The interface circuit of the image sensor device may alternately output at least a portion of the pieces of main line data included in the main data and the pieces of sub-line data included in the sub-data. Accordingly, the image sensor device may provide image data accurately recognizing various types of subjects while reducing degradation of frame rate.

In an example embodiment, the interface circuit of the image sensor device may output the main data and the sub-data in sequence. In example embodiments, the interface circuit may output the main data and the sub-data by matching the main data to the sub-data in one to one manner, or may output the sub-data only once while outputting the main data two or more times.

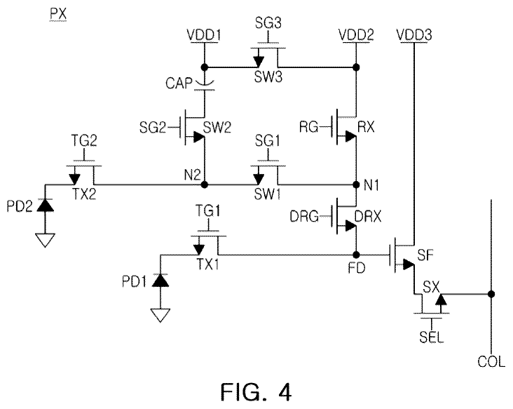

FIG. 4 is a circuit diagram illustrating a pixel included in an image sensor device according to an example embodiment.

Referring to FIG. 4, a pixel PX according to an example embodiment may include a first photodiode PD1, a second photodiode PD2 and a pixel circuit. The pixel circuit may include a floating diffusion node FD, a first transfer transistor TX1, a second transfer transistor TX2, a gain control transistor DRX, a capacitor CAP, a first switch transistor SW1, a second switch transistor SW2, a third switch transistor SW3, a reset transistor RX, an amplification transistor SF, and a selection transistor SX. Control signals for controlling a plurality of transistors included in the pixel circuit may be output by a row driver. For example, the control signal may include, but is not limited to, a first transfer control signal TG1, a second transfer control signal TG2, a reset signal RG, a first switch signal SG1, a second switch signal SG2, a third switch signal SG3, a gain control signal DRG, and a selection signal SEL

The floating diffusion node FD may be connected to the first photodiode PD1 through the first transfer transistor TX1, and based on the first transfer transistor TX1 being turned on by the first transfer control signal TG1, the electric charge of the first photodiode PD1 may be stored in the floating diffusion node FD. The floating diffusion node FD may be connected to the second photodiode PD2 through the second transfer transistor TX2, the first switch transistor SW1, and the gain control transistor DRX. In an operation of transferring the electric charge generated by the second photodiode PD2 to the floating diffusion node FD, the second transfer transistor TX2, the first switch transistor SW1, and the gain control transistor DRX may be turned on by the row driver.

The gain control transistor DRX may be connected between the floating diffusion node FD and the first node N1. In an example case in which the gain control transistor DRX is turned on by the gain control signal DRG, capacitance of the floating diffusion node FD may increase, such that a conversion gain of the pixel PX may decrease. In an example case in which the gain control transistor DRX is turned off, the conversion gain of the pixel PX may increase.

The first switch transistor SW1 may be connected between the first node N1 and the second node N2, and a capacitor CAP and a second switch transistor SW2 may be connected between the second node N2 and the first power node. The first power node may be configured to supply the first power voltage VDD1. The second switch transistor SW2 and the capacitor CAP may be connected in series between the second node N2 and the first power node.

A reset transistor RX may be connected between the first node N1 and the second power node. The second power node may be configured to supply the second power voltage VDD2 and may be connected to a drain of the reset transistor RX. In example embodiments, the second power voltage VDD2 may be the same voltage as the first power voltage VDD1, or may be a voltage different from the first power voltage VDD1. In an example embodiment, the second power voltage VDD2 may be greater than the first power voltage VDD1. A third switch transistor SW3 may be connected between the first power node and the second power node.

A gate of the amplification transistor SF may be connected to the floating diffusion node FD, and the amplification transistor SF may be connected between the third power node and the selection transistor SX. The third power node may be configured to supply the third power voltage VDD3. In example embodiments, the third power voltage VDD3 may be equal to at least one of the first power voltage VDD1 and the second power voltage VDD2. In an example embodiment, the third power voltage VDD3 may be equal to the second power voltage VDD2 and may be greater than the first power voltage VDD1. In an example embodiment, the third power voltage VDD3 may be greater than the first power voltage VDD1 and the second power voltage VDD2.

The amplification transistor SF may operate as a source-follower amplifier and may generate a signal by amplifying the voltage of the floating diffusion node FD. The signal generated by the amplification transistor SF may be output to the column line COL by an operation of turning on the selection transistor SX. The column line COL may be connected to one of the input terminals of the correlated dual sampler. The correlated dual sampler may transfer, to the counter, a signal output to the column line COL and a signal determined based on a ramp voltage.

Operations of the pixel PX may include, but is not limited to, a shutter operation, an exposure operation, and a readout operation. In the shutter operation, electric charge of the floating diffusion node FD and the photodiode PD may be removed. In the exposure operation, the photodiode PD may be exposed to light during a predetermined exposure time and may generate electric charge. In the readout operation, the voltage of the floating diffusion node FD may be amplified and may be output to the column line COL. For example, a reset voltage and a signal voltage may be output to the column line COL. The reset voltage may be a voltage output to the column line COL by the pixel circuit in a state in which the floating diffusion node FD is reset, and the signal voltage may be a voltage output to the column line COL by the pixel circuit in a state in which at least a portion of the electric charges generated by the photodiode PD is stored in the floating diffusion node FD.

In an example embodiment, an operation of outputting a voltage to the column line COL by the pixel circuit after one exposure time may be executed two or more times. For example, a readout operation executed after one exposure time may include a plurality of readout operations executed in sequence. In at least a portion of the plurality of readout operations, conversion gains of the pixel PX may be determined differently.

In an example embodiment, the readout operation may include a high conversion gain (HCG) readout operation of executing under a condition in which the pixel PX has a relatively large conversion gain, and a low conversion gain (LCG) readout operation executed under a condition in which the pixel PX has a relatively small conversion gain. For example, the conversion gain of the LCG readout operation is smaller than the HCG readout operation. In an example embodiment, the readout operation may include a lateral overflow integrated capacitor (LOFIC) readout operation of reading a voltage corresponding to electric charge generated by the FWC or more of photodiodes PD1 and PD2 during the exposure time and stored in the capacitor CAP by overflow.

As described above, by executing two or more readout operations after one exposure time, a signal-to-noise ratio and a dynamic range of the image sensor may be improved. In an example embodiment, depending on a length of the exposure time, the number of readout operations executed after the exposure time, the execution methods of the readout operation may be varied.

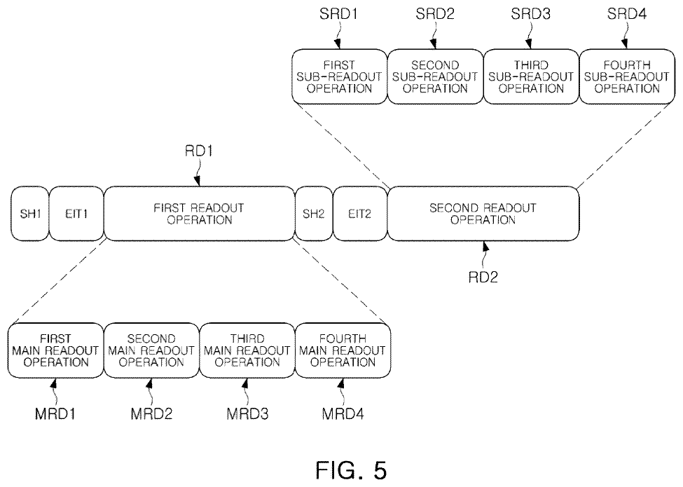

FIG. 5 is a diagram illustrating operations of an image sensor device according to an example embodiment.

FIG. 5 may be a diagram illustrating operations of a pixel included in an image sensor device according to an example embodiment. The pixel may include a first photodiode PD1, a second photodiode PD2 having a light-receiving area smaller than a light-receiving area of the first photodiode PD1, and a pixel circuit. In an example embodiment, pixels included in a pixel array may be arranged in a row direction and a column direction, and may be connected to a row decoder in the row direction and may be connected to a readout circuit in the column direction. The row decoder may drive pixels arranged in the row direction simultaneously, and an operation of a pixel described with reference to FIG. 5 may be executed simultaneously in two or more pixels arranged in the row direction.

According to an embodiment, the operation of the pixel may include, but is not limited to, a first shutter operation SH1, a first exposure time EIT1, a first readout operation RD1, a second shutter operation SH2, a second exposure time EIT2, and a second readout operation RD2. The first exposure time EIT1 and the second exposure time EIT2 may be different, and for example, the first exposure time EIT1 may be longer than the second exposure time EIT2.

The readout circuit may obtain the first pixel signal by the first readout operation RD1 executed after the first exposure time EIT1, and the readout circuit may obtain the second pixel signal by the second readout operation RD2 executed after the second exposure time EIT2. A signal processor of the image sensor device may generate main data using the first pixel signal, and may generate sub-data using the second pixel signal. Each of the main data and the sub-data may be image data, and in an example embodiment, resolution of the main data may be higher than resolution of the sub-data. The interface circuit of the image sensor device may output both the main data and the sub-data within one frame cycle.

In each of the first shutter operation SH1 and the second shutter operation SH2, a reset operation of removing electric charge of the photodiode and a floating diffusion node of the pixel may be executed. For example, in the first shutter operation SH1 and the second shutter operation SH2, the photodiode and the floating diffusion node may be electrically connected to a power node.

During the first exposure time EIT1 and the second exposure time EIT2, the photodiode may be exposed to light to generate electric charge. For example, during the first exposure time EIT1 and the second exposure time EIT2, the transfer transistor may maintain a turned-off state, and the photodiode and the floating diffusion node may be electrically isolated from each other. Accordingly, the electric charge generated by the photodiode may not move to the floating diffusion node.

However, in a circumstance in which intensity of light entering the photodiode is relatively strong, the electric charge may be generated by exceeding the FWC of the photodiode. For example, in an example case in which the intensity of light entering the photodiode is greater than a reference value, the electric charge may be generated by exceeding the FWC of the photodiode. In this case, as the voltage of the node connected to the photodiode and the transfer transistor decreases due to the electric charge generated excessively in the photodiode, leakage through the transfer transistor may occur, and the electric charge generated by the photodiode may move to the floating diffusion node.

In an example embodiment, the pixel may be designed such that electric charge transferred from the photodiode to the floating diffusion node during the first exposure time EIT1 and/or the second exposure time EIT2 may move to a capacitor connected to the floating diffusion node. Accordingly, the electric charge generated by exceeding the FWC of the photodiode in a circumstance in which intensity of light is relatively strong may pass through the floating diffusion node and may be stored in the capacitor. Thereafter, in at least one of the first readout operation RD1 and the second readout operation RD2, the pixel circuit may output a voltage corresponding to the electric charge stored in the capacitor. Accordingly, image data in which a subject is accurately represented may be generated even in a circumstance in which the light intensity is relatively high, and the dynamic range of the image sensor may be improved.

According to an embodiment, a first readout operation RD1 may be executed with respect to pixels for which the first exposure time EIT1 has elapsed, and a second shutter operation SH2 may be started with respect to pixels for which the first readout operation RD1 is completed. Similarly to the first shutter operation SH1, the second shutter operation SH2 may include an operation of selecting pixels along row lines and resetting electric charge of a floating diffusion node and a photodiode. For example, pixels for which the second shutter operation SH2 has been completed may be exposed to light for the second exposure time EIT2. The second exposure time EIT2 may be shorter than the first exposure time EIT1. For pixels for which the second exposure time EIT2 has ended, a second readout operation RD2 may be executed.

As in the example described above, main data generated based on the first pixel signal obtained from pixels in the first readout operation RD1 and sub-data generated based on the second pixel signal obtained from pixels in the second readout operation RD2 may be different from each other. For example, the main data and the sub-data may have different resolutions and color information.

In the example embodiment illustrated in FIG. 5, the first readout operation RD1 may include a plurality of main readout operations, and the second readout operation RD2 may include a plurality of sub-readout operations. The plurality of main readout operations may include, but is not limited to, a first main readout operation MRD1, a second main readout operation MRD2, a third main readout operation MRD3, and a fourth main readout operation MRD4. The plurality of sub-readout operations may include, but is not limited to, a first sub-readout operation MRD1, a second sub-readout operation MRD2, a third sub-readout operation MRD3, and a fourth sub-readout operation MRD4. Referring to FIG. 5, each of the first main readout operation MRD1 and the first sub-readout operation SRD1 may be an operation in which the readout circuit reads a pixel signal corresponding to the electric charge generated by the first photodiode PD1 under the condition in which the pixel has a first conversion gain. The first conversion gain may be a high conversion gain.

The second main readout operation MRD2 and the second sub-readout operation SRD2 may be an operation in which the readout circuit reads a pixel signal corresponding to the electric charge generated by the first photodiode PD1 under the condition in which the pixel has a second conversion gain. The second conversion gain may be a low conversion gain. Each of the third main readout operation MRD3 and the third sub-readout operation SRD3 may be an operation of reading a pixel signal corresponding to electric charge generated by the second photodiode PD2 under the condition in which the pixel has a third conversion gain. The third conversion gain may be a high conversion gain. Each of the fourth main readout operation MRD4 and the fourth sub-readout operation SRD4 may be an operation in which the readout circuit reads a pixel signal corresponding to electric charge generated by exceeding the FWC of the second photodiode PD2 and stored in the capacitor. According to an embodiment, the high conversion gain may mean than the conversion gain is higher than a first conversion gain reference value and the low conversion gain may mean than the conversion gain is lower than a second conversion gain reference value. The first conversion gain reference value and the second conversion gain reference value may be same or different.

In the example embodiment illustrated in FIG. 5, a plurality of main readout operations MRD1-MRD4 and a plurality of sub-readout operations SRD1-SRD4 may be executed in the same scheme and order. However, in example embodiments, the plurality of main readout operations MRD1-MRD4 and the plurality of sub-readout operations SRD1-SRD4 may be executed in different schemes and/or orders.

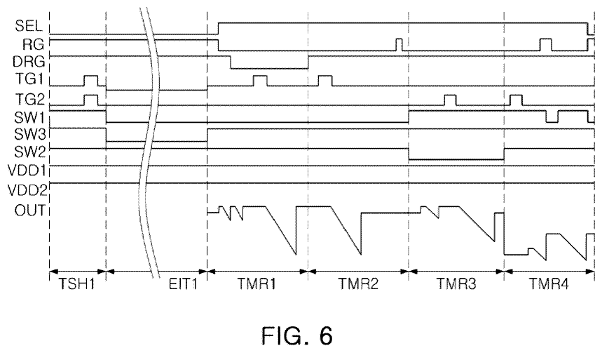

FIGS. 6 to 12 are diagrams illustrating operations of an image sensor device according to an example embodiment.

Each of the pixels PX included in the image sensor described with reference to FIGS. 6 to 12 may have the same structure as the example embodiment described with reference to FIG. 4. FIG. 6 may be a timing diagram illustrating a first shutter operation SH1, a first exposure time EIT1 and a first readout operation RD1 described with reference to FIG. 5 above. In the operation of the pixel PX described with reference to FIGS. 6 to 12, turning on/off of each of the transistors TX1, TX2, RX, SW1, SW2, SW3, DRX, and SX included in the pixel PX may be determined by the control signals TG1, TG2, RG, SG1, SG2, SG3, DRG, and SEL output by the row driver.

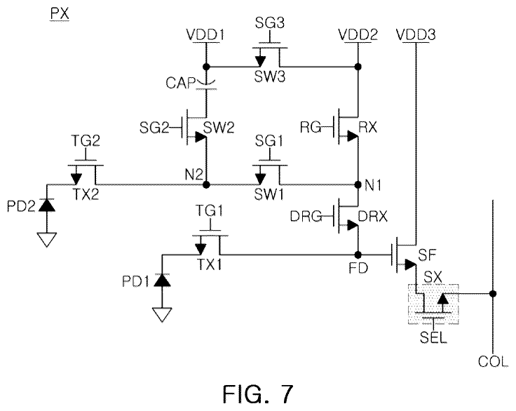

FIG. 7 may be a diagram illustrating operation of the pixel PX during the first shutter operation time TSH1. During the first shutter operation time TSH1, as illustrated in FIGS. 6 and 7, the first transfer transistor TX1, the second transfer transistor TX2, the first switch transistor SW1, the second switch transistor SW2, the third switch transistor SW3, the reset transistor RX, and the gain control transistor DRX may be turned on, and the selection transistor SX may be turned off. Accordingly, electric charge of the first photodiode PD1, the second photodiode PD2, the floating diffusion node FD, and the capacitor CAP may be removed by the first power voltage VDD1 and the second power voltage VDD2.

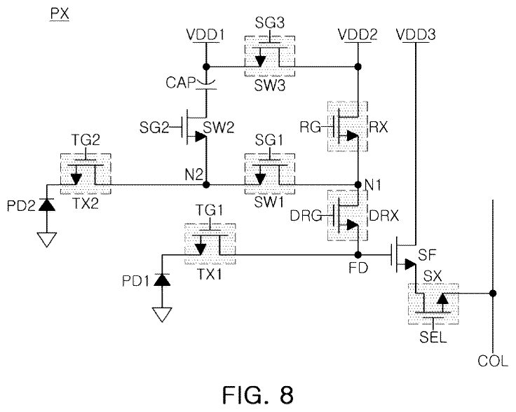

Thereafter, referring to FIGS. 6 and 8, during the first exposure time EIT1, the second switch transistor SW2 may be turned on, and the remaining transistors TX1, TX2, SW1, SW3, RX, DRX, and SX may be turned off. The first photodiode PD1 and the second photodiode PD2 may generate electric charge based on (or in response to light), and the generated electric charge may remain in the first photodiode PD1 and the second photodiode PD2. In a circumstance in which relatively strong light is input, electric charge may be generated by exceeding the FWC of the first photodiode PD1 and the second photodiode PD2. Hereinafter, for ease of description, the electric charge generated by exceeding the FWC of each of the first photodiode PD1 and the second photodiode PD2 may be defined excessive electric charge.

In an example case in which excessive electric charge are generated by the second photodiode PD2, the voltage of the node at which the second transfer transistor TX2 and the second photodiode PD2 are connected to each other, for example, the source voltage of the second transfer transistor TX2, may decrease due to the electric charge. Accordingly, even though the second transfer control signal TG2 input to a gate of the second transfer transistor TX2 is maintained at a voltage corresponding to a logic row, a moving path of electric charge may be formed through the channel of the second transfer transistor TX2, and excessive electric charge of the second photodiode PD2 may move to the second node N2.

In an example embodiment, the second switch transistor SW2 connected to the capacitor CAP may be turned on during the first exposure time EIT1 such that the excessive electric charge moved to the second node N2 may be moved to and stored in the capacitor CAP. The first switch transistor SW1 may be turned off such that the excessive electric charge may not move to the floating diffusion node FD. In example embodiments, the gain control transistor DRX may be turned off together with the first switch transistor SW1 during the first exposure time EIT1.

In an example embodiment, the first transfer control signal TG1 may be determined to a voltage lower than a voltage of the second transfer control signal TG2 during the first exposure time EIT1. The first transfer transistor TX1 may be turned off more strongly than the second transfer transistor TX2, and a moving path of the electric charge due to the excessive electric charge generated by the first photodiode PD1 may not be generated by the first transfer transistor TX1. Accordingly, the excessive electric charge generated by the second photodiode PD2 may be dominantly stored in the capacitor CAP.

In the example embodiment illustrated in FIG. 6, a pixel PX may execute a first readout operation RD1 after the first exposure time EIT1 has elapsed. As in the example described with reference to FIG. 5 above, the first readout operation RD1 may include a plurality of main readout operations MRD1-MRD4.

Referring to FIG. 6, during the first main readout time TMR1, the selection transistor SX may be turned on by the selection control signal SEL, and the reset transistor RX may be turned off. For example, the selection transistor SX may be selectively or preferentially turned on by the selection control signal SEL. In an example case in which the selection transistor SX is turned on, the amplification transistor SF may amplify a voltage of the floating diffusion node FD and may output the reset voltage. The reset voltage may be a voltage output to the column line COL by the pixel circuit in a state in which the floating diffusion node FD is reset.

Referring to FIG. 6, the reset voltage may be output twice. For example, a first reset voltage may be output based on the gain control transistor DRX being turned on, and a second reset voltage may be output based on the gain control transistor DRX being turned off. The first reset voltage may be a reset voltage output based on the pixel PX having a low conversion gain, and the second reset voltage may be a reset voltage output based on the pixel PX has a high conversion gain.

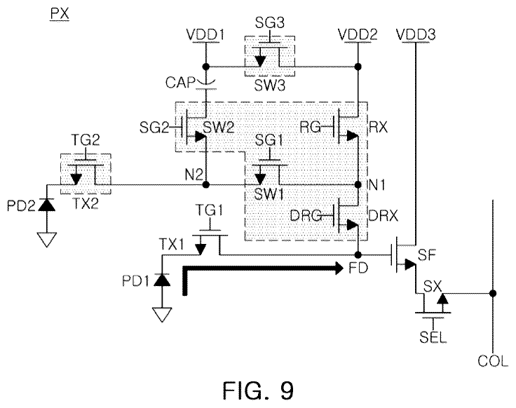

According to an example embodiment, based on the reset voltage being output, the first transfer transistor TX1 may be turned on as illustrated in FIG. 6 and FIG. 9, and the first electric charge of the photodiode PD1 may move to the floating diffusion node FD. The amplification transistor SF may output the signal voltage obtained by amplifying the voltage of the floating diffusion node FD to the column line COL. The readout circuit connected to the column line COL may derive the first main pixel signal from a difference between the reset voltage and the signal voltage.

The first main pixel signal may be a signal for a relatively low first range of illumination. For example, the first main pixel signal may be a signal for covering a relatively low first range of illumination. Referring to FIG. 9, while the pixel PX outputs the signal voltage to the column line COL, the gain control transistor DRX may be turned off. Accordingly, capacitance of the floating diffusion node FD may be maintained sufficiently small, and the signal voltage may be output under the condition in which the pixel PX has a high conversion gain. Since the first transfer transistor TX1 is turned on while capacitance of the floating diffusion node FD is relatively small, only a portion of the electric charges of the first photodiode PD1 may move to the floating diffusion node FD in the operation illustrated in FIG. 9.

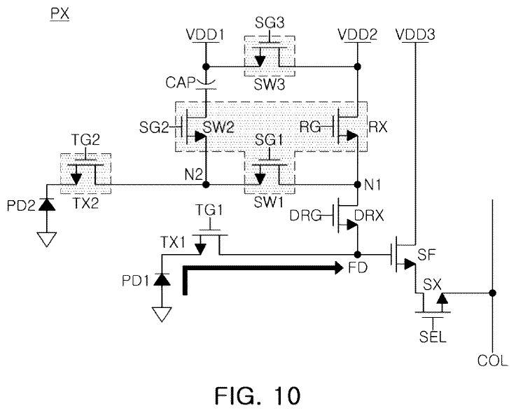

Thereafter, referring to FIGS. 6 and 10, during the second main readout time TMR2, the gain control transistor DRX may be turned on such that the first node N1 may be connected to the floating diffusion node FD. Accordingly, during the second main readout time TMR2, capacitance of the gain control transistor DRX and capacitance of the first node N1 may be added to capacitance of the floating diffusion node FD, and the pixel PX may operate in a low conversion gain state.

According to an embodiment, based on the gain control transistor DRX being turned on and capacitance of the floating diffusion node FD increasing, and based on the first transfer transistor TX1 being turned on, the residual electric charge not moving to the floating diffusion node FD during the first main readout time TMR1 and remained in the first photodiode PD1 may move to the floating diffusion node FD. Accordingly, a second main pixel signal reflecting the residual electric charge not moving to the floating diffusion node FD during the first main readout time TMR1 among electric charges generated by the first photodiode PD1 may be output during the second main readout time TM2. The second main pixel signal may cover an illumination level of a second range higher than the first range covered by the first main pixel signal.

Since at least a portion of the electric charges of the first photodiode PD1 has already transferred to the floating diffusion node FD during the first main readout time TMR1, the reset voltage may not be output before the signal voltage during the second main readout time TMR2. In an example embodiment, the reset voltage may be output twice during the first main readout time TMR1 as in the example described above, and the first reset voltage may be the reset voltage which the pixel PX outputs under a condition of low conversion gain. The readout circuit may generate the second main pixel signal under a low conversion gain state using a difference between the first reset voltage output by the pixel PX during the first main readout time TMR1 and the signal voltage output by the pixel PX during the second main readout time TMR2.

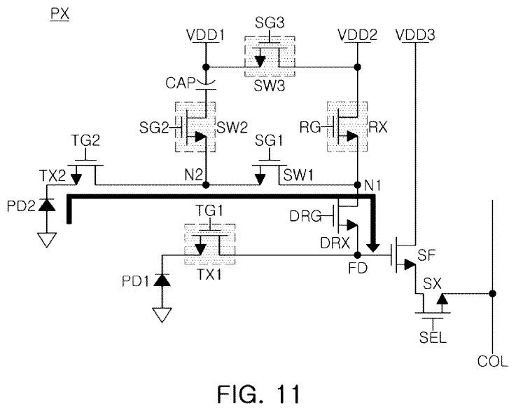

Referring to FIG. 6, the reset transistor RX may be turned on before the end of the second main readout time TMR2 or after the end of the second main readout time TMR2 and the floating diffusion node FD may be reset. Accordingly, the pixel PX may output a reset voltage during the third main readout time TMR3. For example, the pixel PX may selectively or preferentially output a reset voltage during the third main readout time TMR3. According to an embodiment, based on the reset voltage being output, the second transfer transistor TX2, the first switch transistor SW1, and the gain control transistor DRX may be turned on as illustrated in FIG. 6 and FIG. 11.

According to the operation of the pixel PX illustrated in FIG. 11, the electric charge of the second photodiode PD2 may move to the floating diffusion node FD, and the amplification transistor SF may amplify the voltage of the floating diffusion node FD and may output a signal voltage. The readout circuit may generate a third main pixel signal using the difference between the reset voltage and the signal voltage output by the pixel PX during the third main readout time TMR3. The third main pixel signal may be configured to cover the third range of illumination, higher than the second range.

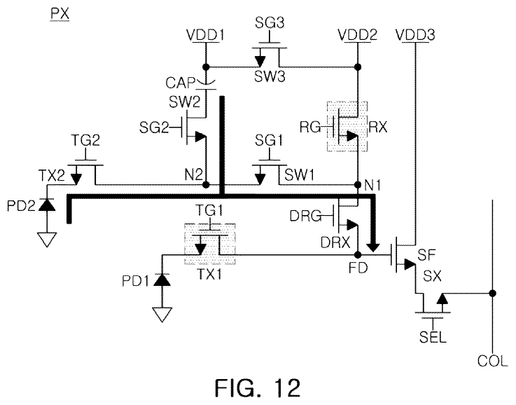

FIG. 12 may be a diagram illustrating operation of the pixel PX during the fourth main readout time TMR4. Referring to FIGS. 6 and 12, during the fourth main readout time TMR4, the first to third switch transistors SW1-SW3, the gain control transistor DRX, and the second transfer transistor TX2 may be turned on. As the first to third switch transistors SW1-SW3 and the gain control transistor DRX are turned on, the electric charge stored in the capacitor CAP may be transferred to the floating diffusion node FD. For example, a signal voltage corresponding to the electric charge stored in the capacitor CAP may be output through the column line COL.

According to an embodiment, based on the signal voltage being output, the row driver may turn on the reset transistor RX. Accordingly, a reset operation in which the electric charge of the floating diffusion node FD is removed may be executed, and the reset voltage may be output through the column line COL. During the fourth main readout time TMR4, the signal voltage may be output before the reset voltage. The readout circuit may derive the fourth main pixel signal using the difference between the reset voltage output by the pixel PX and the signal voltage. The fourth main pixel signal may be for covering the fourth range of illumination, higher than the third range.

As described in the example above, the capacitor CAP may store excessive electric charge generated by exceeding the FWC in the second photodiode PD2 during the first exposure time EIT1. The electric charge may be stored in the capacitor CAP under the condition in which strong light generating electric charge by exceeding the FWC of the second photodiode PD2 flows into the pixel PX. Accordingly, relatively high illumination may be covered using the fourth main pixel signal generated by the electric charge stored in the capacitor CAP.

According to an embodiment, in an example case in which the first shutter operation SH1, the first exposure time EIT1, and the first readout operation RD1 are completed, the pixel PX may execute the second shutter operation SH2, the second exposure time EIT2, and the second readout operation RD2. According to an embodiment, the second shutter operation SH2, the second exposure time EIT2, and the second readout operation RD2 may be performed in a similar manner to the operations illustrated in FIGS. 6-12. For example, other than the configuration in which the second exposure time EIT2 may be shorter than the first exposure time EIT1, the second shutter operation SH2 may be similar to the first shutter operation SH1, and the second readout operation RD2 may be similar to the first readout operation RD1. For example, the description of the first to fourth sub-readout operations SRD1-SRD4 included in the second readout operation RD2 may be similar to the description of the first to fourth main readout operations MRD1-MRD4 described with reference to FIGS. 6, 9 and 12. The readout circuit connected to the pixel PX and the column line COL may obtain the first to fourth sub-pixel signals by the first to fourth sub-readout operations SRD1-SRD4.

For example, in the first readout operation RD1, the first to fourth main pixel signals output by the pixel PX may be merged and may generate the first pixel signal, and in the second readout operation RD2, the first to fourth sub-pixel signals output by the pixel PX may be merged and may generate the second pixel signal. The first pixel signal and the second pixel signal may be transferred to the signal processor by the data output circuit connected to the readout circuit, and the signal processor may generate main data by processing the first pixel signal and may generate sub-data by processing the second pixel signal. However, in example embodiments, the first to fourth main pixel signals and the first to fourth sub-pixel signals may be transferred to the signal processor without being merged.

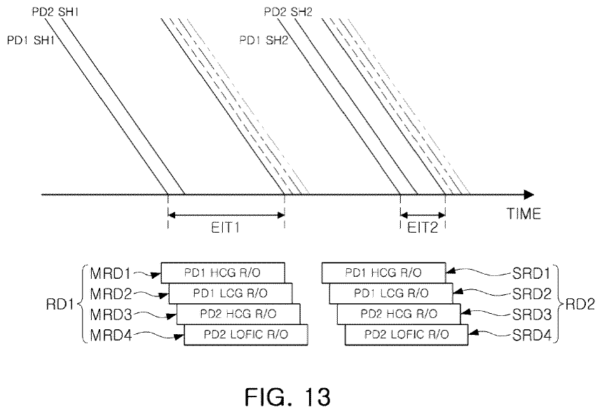

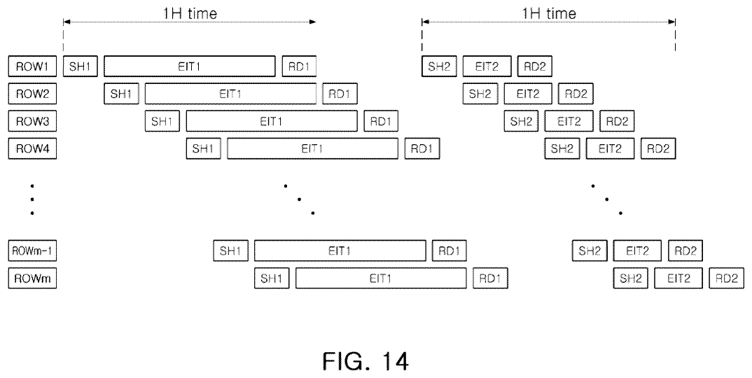

FIGS. 13 and 14 are diagrams illustrating a readout operation of an image sensor device according to an example embodiment.

FIG. 13 may be a diagram illustrating operation of a sensor included in the image sensor device during one frame cycle. The sensor may also be referred to as a sensor unit. For example, the sensor unit may include a pixel array, a row decoder, a readout circuit, a data output circuit, and a ramp generator.

The row decoder may control pixels included in the pixel array as a row line unit. For example, a first shutter operation SH1 may be executed on pixels selected by the row decoder. In an example embodiment, the first shutter operation SH1 may be executed in sequence from pixels of a row line in which the second readout operation RD2 in the previous frame cycle has ended. Accordingly, in example embodiments, while the second readout operation RD2 for pixels of a specific row line is executed, the first shutter operation SH1 for pixels of another row line may be executed. In an example case in which the first shutter operation SH1 is executed on pixels arranged along one of the row lines, electric charge of the floating diffusion node and the photodiode of the pixels may be removed.

In the example embodiment illustrated in FIG. 13, the first shutter operation SH1 for the first photodiode PD1 and the first shutter operation SH1 for the second photodiode PD2 may be executed at different times. Referring to FIG. 4 described above as an example, by turning on the first transfer transistor TX1 and the second transfer transistor TX2 at different times, the first shutter operation SH1 for the first photodiode PD1 and the first shutter operation SH1 for the second photodiode PD2 may be executed at different times. However, the first shutter operation SH1 of each of the first photodiode PD1 and the second photodiode PD2 may be executed at the same time.

After the first shutter operation SH1 is completed, the pixels may be exposed to light during the first exposure time EIT1. The first exposure time EIT1 may be defined as the time from when the first shutter operation SH1 is completed to before the first readout operation RD1 is executed in each pixel. The first readout operation RD1 may include a plurality of main readout operations MRD1-MRD4 executed in sequence, and for example, a plurality of main readout operations MRD1-MRD4 may output first to fourth main pixel signals using different schemes for each pixel.

In pixels at which the first readout operation RD1 has been completed, a second shutter operation SH2 may be executed. In example embodiments, at a time point at which the first readout operation RD1 for pixels connected to a portion of the row lines has not been completed, a second shutter operation SH2 may be initiated for pixels connected to different row lines. For example, while pixels connected to one row line execute the first readout operation RD1, the second shutter operation SH2 may be executed for pixels connected to another row line.

Similarly to the first shutter operation SH1, the second shutter operation SH2 may include an operation of selecting pixels along the row lines and resetting the electric charge of the floating diffusion node and the photodiode. Similarly to the first shutter operation SH1, the second shutter operation SH2 for the first photodiode PD1 and the second shutter operation SH2 for the second photodiode PD2 may be executed at different times. The pixels at which the second shutter operation SH2 is completed may be exposed to light during the second exposure time EIT2. The second exposure time EIT2 may be shorter than the first exposure time EIT1.

In the pixels at which the second exposure time EIT2 is ended, the second readout operation RD2 may be executed. The second readout operation RD2 may include a plurality of sub-readout operations SRD1-SRD4 executed with different schemes. The first to fourth sub-pixel signals may be output by the plurality of sub-readout operations SRD1-SRD4 executed with different schemes.

In the example embodiment described with reference to FIG. 13, a first shutter operation SH1, a first exposure time EIT1, a first readout operation RD1, a second shutter operation SH2, a second exposure time EIT2, and a second readout operation RD2 may be included in one frame cycle. In the example embodiment illustrated in FIG. 13, a command including a first preset to be applied to the sensor unit during the first shutter operation SH1, the first exposure time EIT1, and the first readout operation RD1, and a second preset to be applied to the sensor unit during the second shutter operation SH2, the second exposure time EIT2, and the second readout operation RD2 may be transmitted in advance from a signal processor to the sensor unit. The sensor unit may operate according to the first preset and the second preset included in the command received from the signal processor prior to the start of the frame cycle.

In an example embodiment, a length of each of the first exposure time EIT1 and the second exposure time EIT2 may be included in a command and may be transmitted from the signal processor to the sensor unit. The sensor unit may execute the first shutter operation SH1, the first exposure time EIT1, and the first readout operation RD1 according to the first preset, may change the settings according to the second preset and may execute the second shutter operation SH2, the second exposure time EIT2, and the second readout operation RD2.

The signal processor may generate main data by processing the first pixel signal including the first to fourth main pixel signals, and may generate sub-data by processing the second pixel signal including the first to fourth sub-pixel signals. For example, the first pixel signal may be generated by merging the first to fourth main pixel signals, and the second pixel signal may be generated by merging the first to fourth sub-pixel signals. Each of the main data and the sub-data may be image data, and may have different resolutions and color information. For example, the signal processor may generate main data, which is an image frame of the first resolution by processing the first pixel signal, and may generate sub-data, which is an image frame of the second resolution lower than the first resolution by applying a digital binning process to the second pixel signal.

Referring to FIG. 14, while selecting the plurality of row lines ROW1-ROWm in order, shutter operations SH1, SH2, exposure times EIT1 and EIT2, and readout operations RD1 and RD2 may be executed for each horizontal period 1H time. The row decoder may execute the first shutter operation SH1 and the first exposure time EIT1 on pixels while selecting a plurality of row lines in order, and the readout circuit may execute the first readout operation RD1 for pixels connected to the row line in which the first exposure time EIT1 ends.

The row decoder may execute the second shutter operation SH2 and the second exposure time EIT2 on pixels while selecting a plurality of row lines in order, and the readout circuit may execute the second readout operation RD2 for pixels connected to the row line in which the second exposure time EIT2 ends. The second readout operation RD2 may be executed with the same scheme as the first readout operation RD1, and accordingly, the dynamic range of the sub-data may be sufficiently assured. Accordingly, the subject to be obtained with the sub-data, for example, a subject moving at high speed, may be accurately recognized.

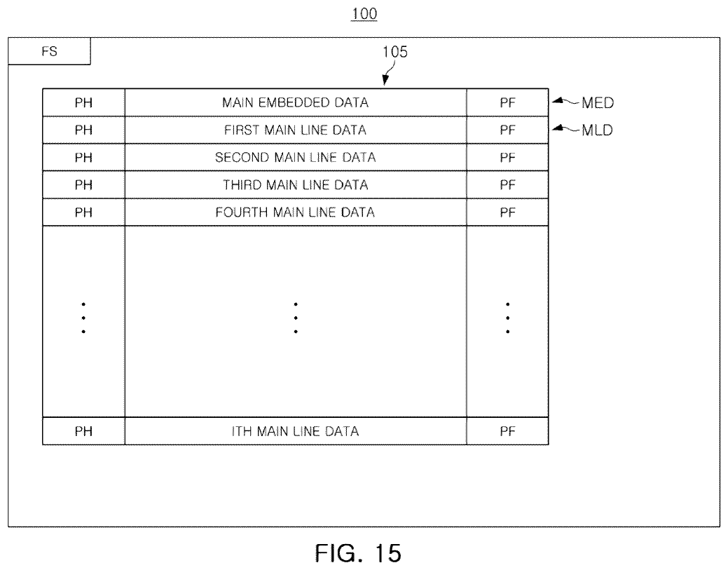

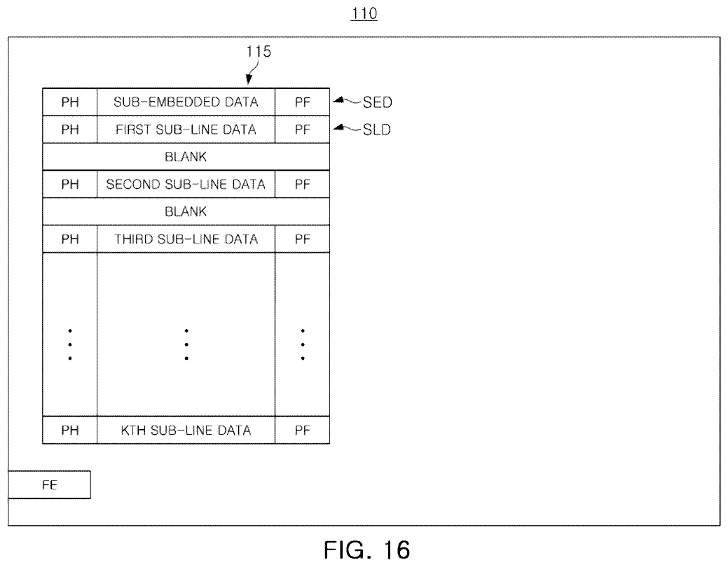

FIGS. 15 and 16 are diagrams illustrating operations of an interface circuit included in an image sensor device according to an example embodiment.

FIGS. 15 and 16 are diagrams illustrating the frame structure of image data output by an interface circuit included in an image sensor device. The image data may include main data 105 (as illustrated in FIG. 15) and sub-data 115 (as illustrated in FIG. 16). The main data 105 and the sub-data 115 may be output in sequence. The interface circuit may be a device configured to transmit the main data 105 and the sub-data 115 generated by the signal processor to an external device. For example, depending on the MIPI interface, the interface circuit may generate and output a main frame 100 including the main data 105 and a sub-frame 110 including the sub-data 115.

According to an embodiment, as illustrated in FIG. 15 and FIG. 16, the main frame 100 including the main data 105 may not include a packet FE indicating the end of frame (see FIG. 15), and the sub-frame 110 including the sub-data 115 may not include the packet FS indicating the start of frame (see FIG. 16). Accordingly, the main frame 100 and the sub-frame 110 may be output in sequence in one frame cycle.

Referring to FIG. 15, the main frame 100 may include a packet FS indicating the start of frame, main embedded data MED, and a plurality of pieces of the main line data MLD. Each of the main embedded data MED and the plurality of pieces of the main line data MLD may include a packet header PH and a packet footer PF. The main embedded data MED may include information such as the exposure time, high dynamic range (HDR) information, white balance, and a gain applied to the main data 105.

Each of the plurality of pieces of main line data MLD may include valid data corresponding to two or more pixels, and an image represented as the main data 105 may be determined by the valid data. A horizontal blank section may be present before and after each of the main embedded data MED and the plurality of pieces of main line data MLD in the horizontal direction in FIG. 15, and a vertical blank section may be present after the last main line data in the vertical direction in FIG. 15.

Referring to FIG. 16, the interface circuit may transmit a sub-frame 110 after transmission of the main frame 100 is completed. The sub-frame 110 may not include the packet FS indicating the start of the frame, and may include only the packet FE indicating the end of the frame. The sub-data 115 may include sub-embedded data SED and a plurality of pieces of sub-line data SLD. Each of the sub-embedded data SED and the plurality of pieces of sub-line data SLD may include a packet header PH and a packet footer PF.

As described in the example above, the signal processor may generate the sub-data 115 by processing the second pixel signal, and this process may include a digital binning process. Accordingly, each of the plurality of pieces of sub-line data SLDs may include valid data having capacity smaller than capacity of each of the plurality of pieces of main line data MLDs. Also, the number of the plurality of pieces of sub-line data SLDs included in the sub-data 115 may be smaller than the number of the plurality of pieces of main line data MLDs included in the main data 105. By the digital binning process, pieces of blank data BDs may be inserted between the plurality of pieces of sub-line data SLDs as illustrated in FIG. 16. In an example embodiment, the sum of the number of the plurality of pieces of sub-line data SLDs and the number of pieces of blank data BDs may be equal to the number of the plurality of pieces of main line data MLDs. The signal processor may process the main data 105 and the sub-data 115 using one signal processing chain.

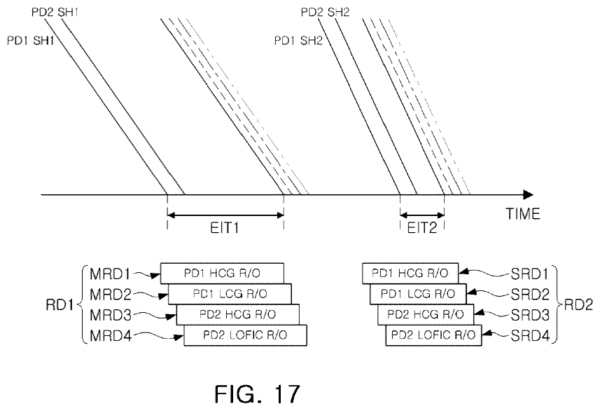

FIG. 17 is a diagram illustrating a readout operation of an image sensor device according to an example embodiment.

FIG. 17 may be a diagram illustrating the operation of the sensor unit included in the image sensor device during one frame cycle. The sensor unit may include a pixel array, a row decoder, a readout circuit, a data output circuit, and a ramp generator. The operation of the sensor unit described with reference to FIG. 17 may be similar to the operation of the sensor unit described with reference to FIG. 13. For example, the sensor unit may execute a first shutter operation SH1, a first exposure time EIT1, a first readout operation RD1, a second shutter operation SH2, a second exposure time EIT2, and a second readout operation RD2 during one frame cycle.

However, in the example embodiment illustrated in FIG. 17, the sensor unit may execute a second shutter operation SH2, a second exposure time EIT2, and a second readout operation RD2 while applying an analog binning to two or more pixels. Accordingly, the number of row lines determining the execution order of the second shutter operation SH2, the second exposure time EIT2 and the second readout operation RD2 may be less than the number of row lines determining the execution order of the first shutter operation SH1, the first exposure time EIT1 and the first readout operation RD1.

Similarly to the example described with reference to FIG. 13, in the example embodiment illustrated in FIG. 17, a command including a first preset to be applied to the sensor unit during the first shutter operation SH1, the first exposure time EIT1, and the first readout operation RD1, and a second preset to be applied to the sensor unit during the second shutter operation SH2, the second exposure time EIT2, and the second readout operation RD2 may be transmitted in advance from the signal processor to the sensor unit. The sensor unit may operate according to the first preset and the second preset included in the command received from the signal processor prior to the start of the frame cycle. In an example embodiment, the lengths of the first exposure time EIT1 and the second exposure time EIT2 may be included in the command and may be transmitted from the signal processor to the sensor unit. The sensor unit may execute the first shutter operation SH1, the first exposure time EIT1, and the first readout operation RD1 according to the first preset, may change the settings according to the second preset and may execute the second shutter operation SH2, the second exposure time EIT2, and the second readout operation RD2.

The signal processor may generate main data by processing the first pixel signal including the first to fourth main pixel signals, and may generate sub-data by processing the second pixel signal including the first to fourth sub-pixel signals. Each of the main data and the sub-data may be image data, and may have different resolutions and color information. Since analog binning is applied selectively or preferentially before the second readout operation RD2, the signal processor may not apply a digital binning process to the second pixel signal in the example embodiment illustrated in FIG. 17. The signal processor may process the main data 125 and the sub-data 135 using one signal processing chain.

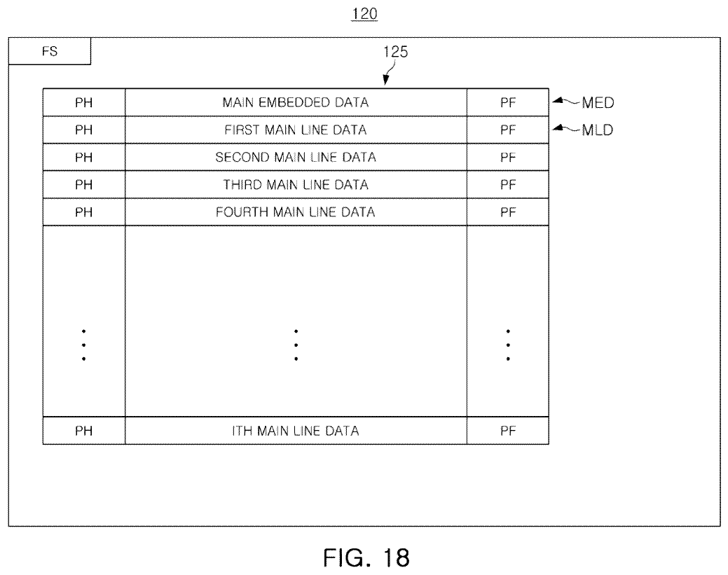

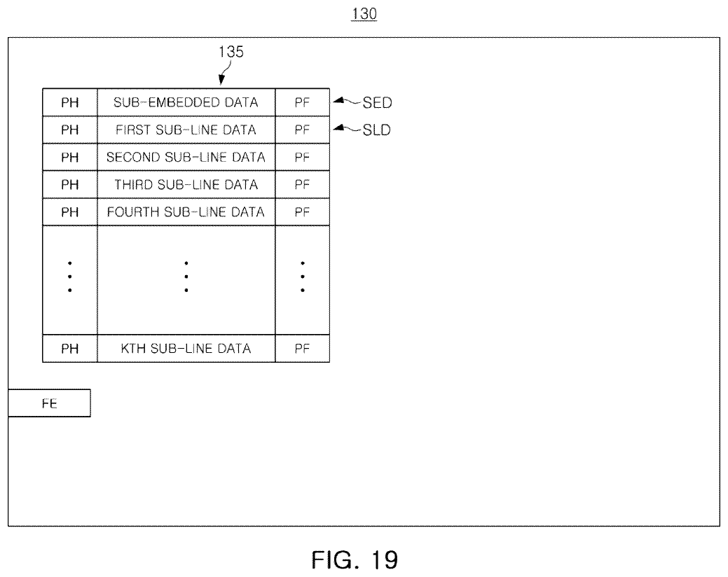

FIGS. 18 and 19 are diagrams illustrating operations of an interface circuit included in an image sensor device according to an example embodiment.

FIG. 18 and FIG. 19 are diagrams illustrating the frame structure of image data output by the interface circuit included in the image sensor device. The image data may include the main data 125 and the sub-data 135, and the main data 125 and the sub-data 135 may be output in sequence. However, as illustrated in FIG. 18 and FIG. 19, the main frame 120 including the main data 125 may not include a packet FE indicating the end of the frame, and the sub-frame 130 including the sub-data 135 may not include a packet FS indicating the start of the frame. Accordingly, the main frame 120 and the sub-frame 130 may be output in one frame cycle.

The main frame 120 may include a packet FS indicating the start of the frame, main embedded data MED, and a plurality of pieces of main line data MLD. Each of the main embedded data MED and a plurality of pieces of main line data MLD may include a packet header and a packet footer. The main embedded data MED may include information such as exposure time, high dynamic range (HDR) information, white balance, and a gain applied to the main data 125. The structure of the main frame 120 may be similar to the example described above with reference to FIG. 15.

The interface circuit may transmit the sub-frame 130 after the transmission of the main frame 120 is completed. The sub-frame 130 may include only the packet FE indicating the end of the frame without including the packet FS indicating the start of the frame. The sub-data 135 may include sub-embedded data SED and a plurality of pieces of sub-line data SLD.

In the example embodiment described with reference to FIG. 19, the sensor unit may execute a second readout operation by applying analog binning, and may provide a second pixel signal obtained by the second readout operation to a signal processor. Accordingly, a digital binning process may not be included in the process in which the signal processor generates sub-data 135 by processing the second pixel signal.

According to an embodiment, since the second pixel signal is generated by analog binning, each of the plurality of pieces of sub-line data SLDs may include valid data having capacity smaller than that of each of the plurality of pieces of main line data MLD. Also, the number of the plurality of pieces of sub-line data SLDs included in the sub-data 135 may be smaller than the number of the plurality of pieces of main line data MLDs included in the main data 125. Since analog binning is applied, blank data may not be inserted between the plurality of pieces of sub-line data SLDs. Accordingly, as compared to the example embodiment illustrated in FIG. 16, a packet FE indicating the end of a frame in the example embodiment illustrated in FIG. 19 may be output at an earlier time point. Also, a length of a vertical blank section included in the sub-frame 130 may be relatively longer than that in the main frame 120.

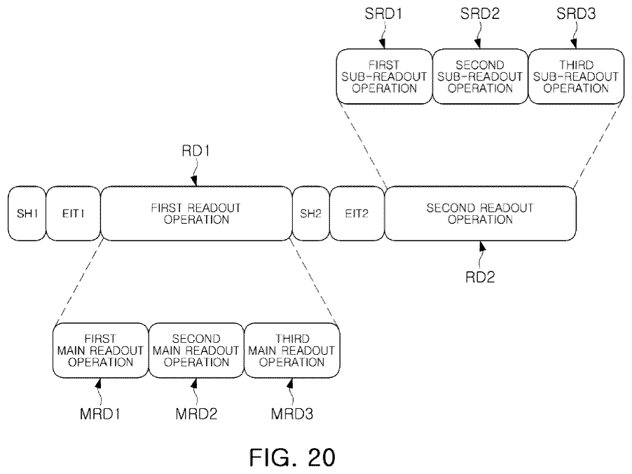

FIG. 20 is a diagram illustrating operations of an image sensor device according to an example embodiment.

FIG. 20 may be a diagram illustrating operation of a pixel included in an image sensor device according to an example embodiment. The pixel may include a first photodiode PD1, a second photodiode PD2 having a light-receiving area smaller than a light-receiving area of the first photodiode PD1, and a pixel circuit. In an example embodiment, pixels included in a pixel array may be arranged in the row direction and the column direction, and may be connected to a row decoder in the row direction and may be connected to a readout circuit in the column direction. The row decoder may drive pixels arranged in the row direction simultaneously, and accordingly, an operation of a pixel described with reference to FIG. 20 may be executed simultaneously in two or more pixels arranged in the row direction.

The operation of a pixel may include a first shutter operation SH1, a first exposure time EIT1, a first readout operation RD1, a second shutter operation SH2, a second exposure time EIT2, and a second readout operation RD2. The first exposure time EIT1 and the second exposure time EIT2 may be different, and for example, the first exposure time EIT1 may be longer than the second exposure time EIT2.

The operation of the pixel according to the example embodiment described with reference to FIG. 20 may be similar to the operation of the pixel according to the example embodiment described with reference to FIG. 5. However, in the example embodiment illustrated in FIG. 20, the first readout operation RD1 may include a first main readout operations MRD1, a second main readout operations MRD2, and a third main readout operations MRD3, and the second readout operation RD2 may include a first sub-readout operations SRD1, a second sub-readout operations SRD2, and a third sub-readout operations SRD3.

The first to third main readout operations MRD1-MRD3 and the first to third sub-readout operations SRD1-SRD3 may match each other according to order. The first main readout operation MRD1 and the first sub-readout operation SRD1 may be operations of reading a signal corresponding to electric charge of the first photodiode PD1 having a relatively large light-receiving area under a high conversion gain state. The second main readout operation MRD2 and the second sub-readout operation SRD2 may be operations of reading a signal corresponding to the electric charge of the first photodiode PD1 under a low conversion gain state. The third main readout operation MRD3 and the third sub-readout operation SRD3 may be operations of reading a signal corresponding to the electric charge generated by the second photodiode PD2 having a small light-receiving area and stored in the capacitor of the pixel.

The signal processor may generate main data using the first pixel signal for merging the first to third main pixel signals generated by the first readout operation RD1, and may generate sub-data using the second pixel signal for merging the first to third sub-pixel signals generated by the second readout operation RD2. In an example embodiment, resolution of the main data may be higher than resolution of the sub-data. The interface circuit of the image sensor device may output both the main data and the sub-data within one frame cycle.

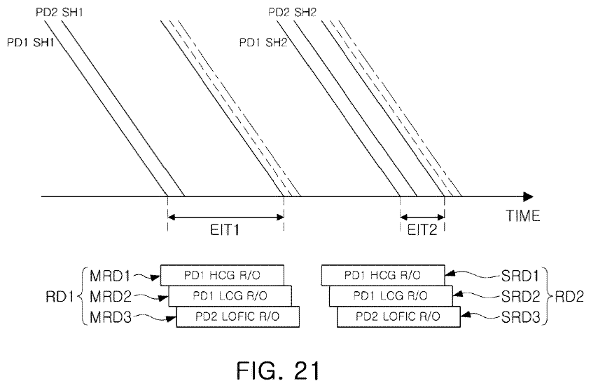

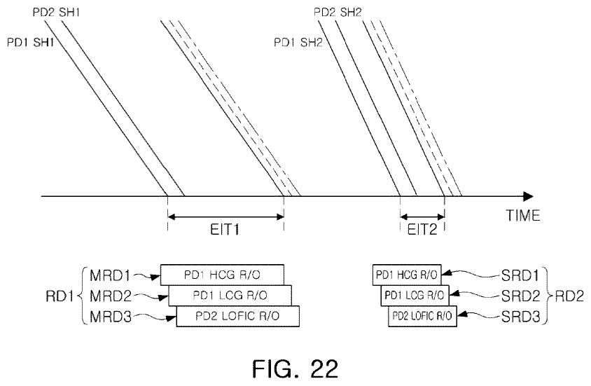

FIGS. 21 and 22 are diagrams illustrating a readout operation of an image sensor device according to an example embodiment.

FIGS. 21 and 22 may be diagrams illustrating operation of the sensor unit included in the image sensor device during one frame cycle. The sensor unit may include a pixel array, a row decoder, a readout circuit, a data output circuit, and a ramp generator. The operation of the sensor unit described with reference to FIG. 21 may be similar to the operation of the sensor unit described with reference to FIG. 13. The operation of the sensor unit described with reference to FIG. 22 may be similar to the operation of the sensor unit described with reference to FIG. 17.

However, in each of the example embodiments illustrated in FIGS. 21 and 22, the first readout operation RD1 may include first to third main readout operations MRD1-MRD3, and the second readout operation RD2 may include first to third sub-readout operations SRD1-SRD3. Each of the first to third main readout operations MRD1-MRD3 and the first to third sub-readout operations SRD1-SRD3 may be executed with the same scheme as in the example described with reference to FIG. 20.

In the example embodiments described with reference to FIGS. 21 and 22, the sensor unit may operate based on a command previously received from the signal processor. For example, the command may include a first preset to be applied to the sensor unit during the first shutter operation SH1, first exposure time EIT1, and first readout operation RD1, and a second preset to be applied to the sensor unit during the second shutter operation SH2, second exposure time EIT2, and second readout operation RD2.

The sensor unit operating according to the first preset may output first to third main pixel signals by the first readout operation RD1, and the sensor unit operating according to the second preset may output first to third sub-pixel signals by the second readout operation RD2. The signal processor may generate main data by processing the first pixel signal which merges the first to third main pixel signals, and may generate sub-data by processing the second pixel signal which merges the first to third sub-pixel signals. In the example embodiment illustrated in FIG. 21, the process of processing the second pixel signal may include a digital binning process. In the example embodiment illustrated in FIG. 22, the sensor unit may execute the second readout operation RD2 by applying analog binning. Accordingly, resolution of the main data may be higher than resolution of the sub-data.

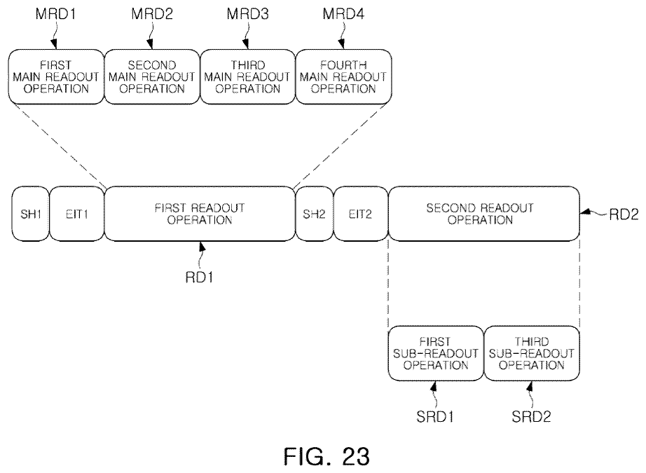

FIG. 23 is a diagram illustrating operations of an image sensor device according to an example embodiment.

In the example embodiment described with reference to FIG. 23, a pixel may include a first photodiode PD1, a second photodiode PD2 having a light-receiving area smaller than a light-receiving area of the first photodiode PD1, and a pixel circuit. In an example embodiment, the pixels may be arranged in a pixel array in the row and column directions, and may be connected to a row decoder in the row direction and to a readout circuit in the column direction.

The operation of the pixel may include a first shutter operation SH1, a first exposure time EIT1, a first readout operation RD1, a second shutter operation SH2, a second exposure time EIT2, and a second readout operation RD2. The first exposure time EIT1 and the second exposure time EIT2 may be different, and for example, the first exposure time EIT1 may be longer than the second exposure time EIT2.

Referring to FIG. 23, the first readout operation RD1 may include first to fourth main readout operations MRD1-MRD4. The readout circuit may obtain and output first to fourth main pixel signals by executing the first to fourth main readout operations MRD1-MRD4. In the example embodiment illustrated in FIG. 22, the second readout operation RD2 may include first and second sub-readout operations SRD1, SRD2. Accordingly, the first readout operation RD1 and the second readout operation RD2 may be executed with different schemes.

For example, the first sub-readout operation SRD1 may be executed with the same scheme as the first main readout operation MRD1, and the second sub-readout operation SRD2 may be executed with the same scheme as the third main readout operation MRD3. The readout circuit may obtain and output first to fourth main pixel signals by executing the second readout operation RD2. However, the configuration of the first readout operation RD1 and the second readout operation RD2 is not necessarily limited to the example illustrated in FIG. 22, and may be varied in example embodiments.

The signal processor may generate main data using first to fourth main pixel signals, and may generate sub-data using first and second sub-pixel signals. In an example embodiment, resolution of the main data may be higher than resolution of the sub-data. An interface circuit of the image sensor device may alternately output a portion of a plurality of pieces of main line data included in the main data and at least a portion of a plurality of pieces of sub-line data included in the sub-data. Accordingly, a frame rate of the image sensor device may be increased as compared to a method of outputting the sub-data after the output of the main data is completed. A method by which the interface circuit outputs the main data and the sub-data will be described later.

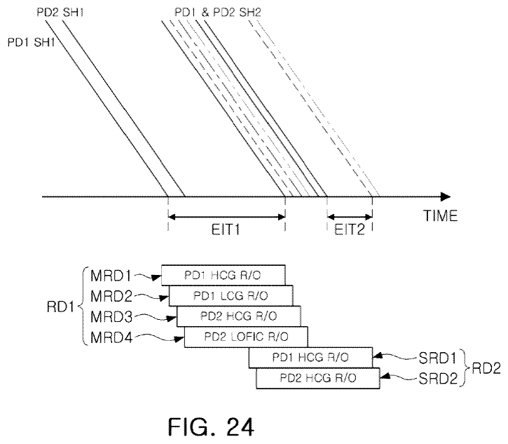

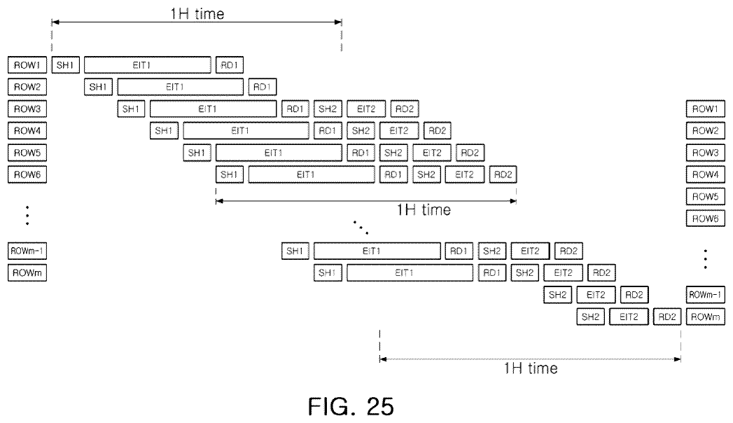

FIGS. 24 and 25 are diagrams illustrating a readout operation of an image sensor device according to an example embodiment.

FIG. 24 may be a diagram illustrating the operation of the sensor unit included in the image sensor device during one frame cycle. The sensor unit may include a pixel array, a row decoder, a readout circuit, a data output circuit, and a ramp generator.

Referring to FIG. 24, pixels may be selected along row lines in the pixel array of the image sensor, and a first shutter operation SH1 may be executed. The first shutter operation SH1 may be executed in sequence along the row lines. As the first shutter operation SH1 is executed in pixels arranged along one of the row lines, a floating diffusion node of the pixels and the electric charge of the photodiode may be removed.

In the example embodiment illustrated in FIG. 24, the first shutter operation SH1 for the first photodiode PD1 and the first shutter operation SH1 for the second photodiode PD2 may be executed at different times. However, in example embodiments, the first shutter operation SH1 for the first photodiode PD1 and the first shutter operation SH1 for the second photodiode PD2 may be executed at the same time point.

After the first shutter operation SH1 is completed, the pixels may be exposed to light during a first exposure time EIT1. The first exposure time EIT1 may be defined as a time period from a time of completion of the first shutter operation SH1 in each pixel to a time of execution of the first readout operation RD1. For example, the first exposure time EIT1 may be defined as the time from when the first shutter operation SH1 is completed in each pixel to the time when the first readout operation RD1 is executed. The first readout operation RD1 may include a plurality of main readout operations MRD1-MRD4 executed in sequence, and for example, each of the plurality of main readout operations MRD1-MRD4 may output first to fourth main pixel signals using different schemes.

In the example embodiment illustrated in FIG. 24, the second shutter operation SH2 may be initiated before the first readout operation RD1 is completed for the entirety of pixels. For example, even before the first readout operation RD1 for the entirety of pixels is completed, the second shutter operation SH2 may be executed for pixels for which the first readout operation RD1 is completed by row line unit. For example, the second shutter operation SH2 may be executed for one or more first pixels, among the first pixels, for which the first readout operation RD1 is completed by row line unit, while the first readout operation RD1 is still being performed on one or more second pixels, among the pixels.

Referring to FIG. 24, the second readout operation RD2 may be started for some pixels before the first readout operation RD1 is completed for the entirety of pixels. The second readout operation RD2 may include a plurality of sub-readout operations SRD1 and SRD2, and in each of the plurality of sub-readout operations SRD1 and SRD2, the pixels may operate with different schemes and may output first and second sub-pixel signals. For example, in the example embodiment illustrated in FIG. 24, the sensor unit may operate in a manner in which different row lines shares a horizontal period.

Referring to FIG. 25, in at least a portion of a plurality of horizontal periods, shutter operations SH1, SH2, exposure times EIT1 and EIT2, and readout operations RD1 and RD2 for different row lines may be executed. In a first horizontal period, a first shutter operation SH1, a first exposure time EIT1, and a first readout operation RD1 may be executed for pixels connected to a first row line ROW1. In a second horizontal period, a first shutter operation SH1, a first exposure time EIT1, and a first readout operation RD1 may be executed for pixels connected to a second row line ROW2.

In a third horizontal period, the first shutter operation SH1, the first exposure time EIT1, and the first readout operation RD1 for the pixels connected to the third row line ROW3 may be executed selectively or preferentially, and thereafter, the second shutter operation SH2, the second exposure time EIT2, and the second readout operation RD2 for the pixels connected to the first row line ROW1 may be executed. In other words, the pixels connected to the third row line ROW3 and the pixels connected to the first row line ROW1 may share the third horizontal period.

In the example embodiment illustrated in FIG. 24, in each of a third horizontal period to the mth horizontal period, the first shutter operation SH1, the first exposure time EIT1, and the first readout operation RD1 for the jth (where j is a natural number equal to or greater than 3) row line may be executed selectively or preferentially, and the second shutter operation SH2, the second exposure time EIT2, and the second readout operation RD2 for the j−2th row line may be executed. In the m+1th horizontal period and the m+2th horizontal period, only the second shutter operation SH2, the second exposure time EIT2, and the second readout operation RD2 for the pixels connected to the m−1th row line ROWm−1 and the pixels connected to the mth row line ROWm may be executed. In the example embodiment illustrated in FIG. 25, a horizontal period in which control operations SH1, EIT1, and RD1 for the pixels connected to the jth row line and control operations SH2, EIT2, and RD2 for the pixels connected to the j−2th row line are executed in sequence may appear from the third horizontal period, but an example embodiment thereof is not limited thereto. As another example, a horizontal period in which control operations SH1, EIT1, and RD1 for the pixels connected to the jth row line and control operations SH2, EIT2, and RD2 for the pixels connected to the j−4th row line are executed in sequence may appear from the fifth horizontal period. In this case, j may be a natural number equal to or greater than 5.

Accordingly, in the example embodiment illustrated in FIG. 25, each horizontal period 1H time may be longer than in the example embodiment described with reference to FIG. 14. In the example embodiment described with reference to FIG. 14, the horizontal period 1H time may be repeated by the times twice the number of row lines, whereas in the example embodiment illustrated in FIG. 25, the horizontal period 1H time may be repeated only twice more than the number of row lines. Accordingly, by shortening the frame cycle, the frame rate of the image sensor device may improve. Also, the difference between the time point at which the first shutter operation SH1 is executed and the time point at which the second shutter operation SH2 is executed in each of the plurality of pixels may be reduced, and a difference between imaging times between the main data generated by the signal processor from the first to fourth main pixel signals and the sub-data generated by the first and second sub-pixel signals may be reduced. Accordingly, various types of subjects may be accurately recognized without distortion.

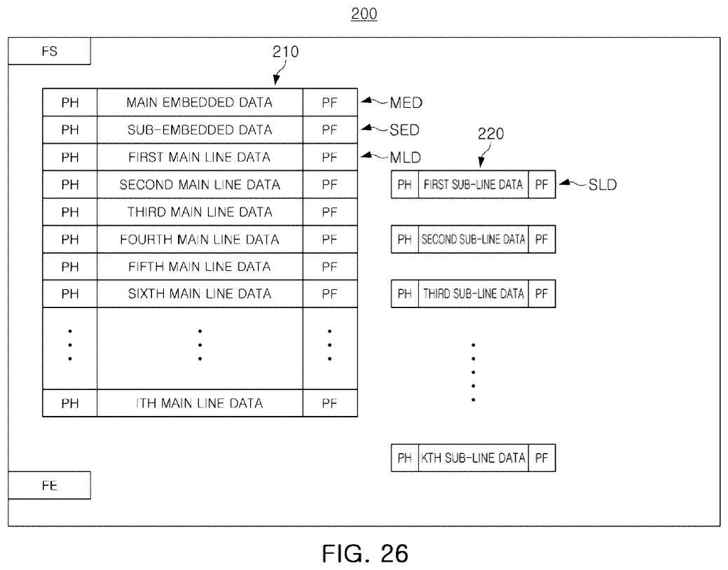

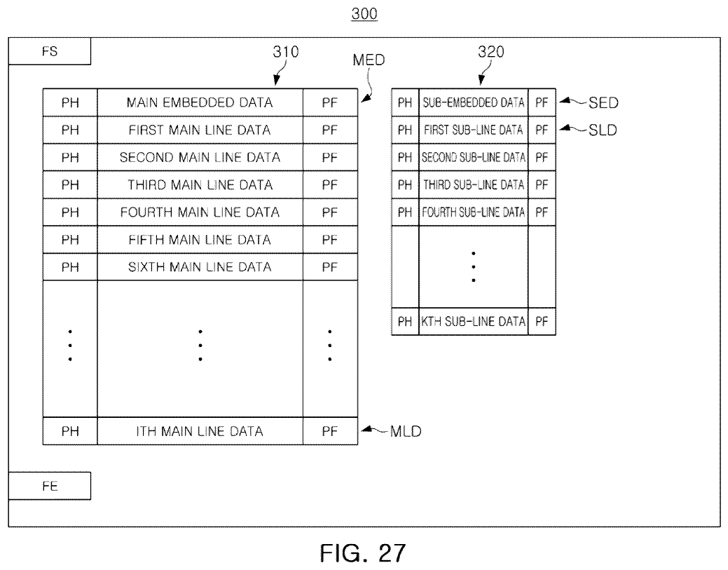

In an image sensor device to which the readout operation as in the example embodiment illustrated in FIGS. 24 and 25 is applied, an interface circuit may transmit the pieces of main line data included in main data and the pieces of sub-line data included in sub-data in a staggered manner. The operation of the interface circuit will be described in greater detail with reference to FIGS. 26 and 27.

FIGS. 26 and 27 are diagrams illustrating operations of an interface circuit included in an image sensor device according to an example embodiment.

FIG. 26 is a diagram illustrating a frame structure of image data 200 output by an interface circuit included in an image sensor device and FIG. 27 is a diagram illustrating a frame structure of image data 300 output by an interface circuit included in an image sensor device. The image data 200, 300 include main data 210 and 310 and sub-data 220 and 320, respectively, and may be transmitted to an external device by the interface circuit. The interface circuit may be a device configured to transmit the main data 210 and 310 and the sub-data 220 and 320 generated by a signal processor to an external device, and may operate according to a MIPI interface, for example.

Referring to FIGS. 26 and 27, the image data 200, 300 may include a packet FS indicating the start of a frame and a packet FE indicating the end of a frame, and the main data 210 and 310 and the sub-data 220 and 320 may be output during the time therebetween. In the example embodiment illustrated in FIGS. 26 and 27, at least a portion of a plurality of pieces of sub-line data SLD may be output between at least a portion of a plurality of pieces of main line data MLD included in the main data 210 and 310.

Referring to FIG. 26, the interface circuit may output main embedded data MED and sub-embedded data SED in sequence after outputting a packet FS indicating the start of a frame. The interface circuit may output a plurality of main line data groups grouping a plurality of pieces of main line data MLD by N number of pieces of main line data (where Nis a natural number equal to or greater than 2) in sequence. In the example embodiment illustrated in FIG. 24, N may be 2. For example, a first main line data grouping the first main line data and the second main line data, and the second main line data group grouping the third main line data and the fourth main line data may be output in sequence.

Also, the interface circuit may output a plurality of sub-line data groups grouping a plurality of pieces of sub-line data by M number of pieces of sub-line data (where M is a natural number less than N) in sequence. In the example embodiment illustrated in FIG. 24, M may be 1. However, N and M are not limited as in the example illustrated in FIG. 24 and may be varied. In an example embodiment, N may be 4 and M may be 2.

The interface circuit may alternately transmit a plurality of main line data groups and a plurality of sub-line data groups. Referring to FIG. 26, after the first main line data group including the first main line data and the second main line data is transmitted, the first sub-line data may be transmitted, and the second main line data group grouping the third main line data and the fourth main line data may be transmitted.

As described above, the interface circuit may transmit a plurality of pieces of main line data MLD and a plurality of pieces of sub-line data SLD in a staggered manner. The interface circuit may transmit a plurality of pieces of main line data MLD and a plurality of pieces of sub-line data SLD in a synchronized manner in a horizontal period, and the main line data MLD and the sub-line data SLD may be output one by one in at least one horizontal period. Also, only the main line data MLD or the sub-line data SLD may be output in another horizontal period. For example, the second main line data and the first sub-line data may be output in sequence during one horizontal period. Also, the first main line data may be output alone during one horizontal period, and the kth sub-line data may also be output alone during one horizontal period.

A signal processor configured to generate the main data 210 and the sub-data 220 may generate the sub-data 220 by applying a digital binning process to the first and second sub-pixel signals received from the readout circuit. Accordingly, the number of the plurality of pieces of sub-line data SLD may be smaller than the number of the plurality of pieces of pieces of main line data MLD. Also, capacity of the valid data included in each of the plurality of pieces of sub-line data SLD may be smaller than capacity of the valid data included in each of the plurality of pieces of main line data MLD. Accordingly, during a horizontal period, the time during which the second main line data is output may be longer than the time during which the first sub-line data is output.

Referring to FIG. 27, the interface circuit may output the main embedded data MED and the sub-embedded data SED in sequence after the packet FS indicating the start of the frame is output. The interface circuit may alternately output the plurality of pieces of main line data MLD and the plurality of pieces of sub-line data SLD in synchronization with a predetermined horizontal period.

In FIG. 27, the signal processor may apply an analog binning process to the process of generating the sub-data 320, and as such, the number of the plurality of pieces of sub-line data SLD may be smaller than the number of the plurality of pieces of main line data MLD. Accordingly, as illustrated in FIG. 27, transmission of the sub-data 320 may be ended before transmission of the main data 310. After transmission of the sub-data 320 is ended, only the main data 310 may be output by the interface circuit. In the example embodiments described with reference to FIGS. 26 and 27, the interface circuit may output main data 210 and 310 and sub-data 220 and 320 through different virtual channels defined in the MIPI interface.

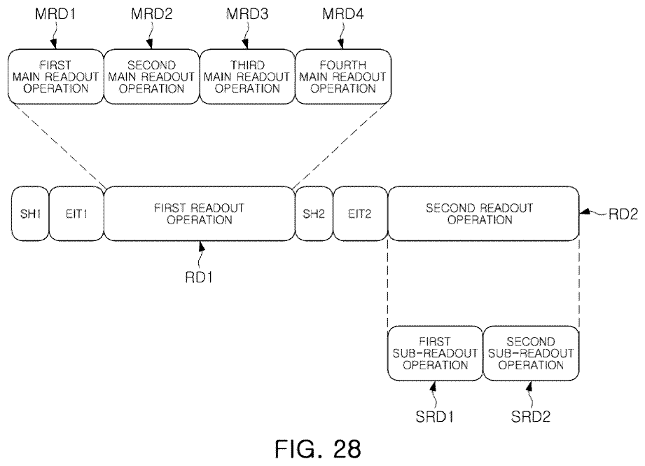

FIG. 28 is a diagram illustrating operations of an image sensor device according to an example embodiment.

In the example embodiment illustrated in FIG. 28, the operation of the pixel may include a first shutter operation SH1, a first exposure time EIT1, a first readout operation RD1, a second shutter operation SH2, a second exposure time EIT2, and a second readout operation RD2. The operation of the pixel according to the example embodiment illustrated in FIG. 28 may be similar to the example described with reference to FIG. 23. Unlike the example embodiment described with reference to FIG. 23, in the example embodiment illustrated in FIG. 28, a first sub-readout operation SRD1 of a second readout operation RD2 may be executed with the same scheme as a first main readout operation MRD1, and a second sub-readout operation SRD2 may be executed with the same scheme as a second main readout operation MRD2.

However, the configuration of the first readout operation RD1 and the second readout operation RD2 is not necessarily limited to the example illustrated in FIG. 23, and may be varied in example embodiments. For example, the number of sub-readout operations SRD1 and SRD2 included in the second readout operation RD2 may be selected as three or more.

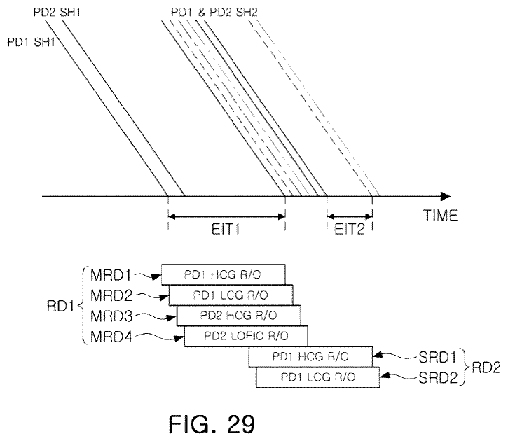

FIG. 29 is a diagram illustrating a readout operation of an image sensor device according to an example embodiment.

FIG. 29 may be a diagram illustrating the operation of a sensor unit included in an image sensor device during one frame cycle. The operation of the sensor unit according to the example embodiment illustrated in FIG. 29 may be similar to the example described with reference to FIG. 24 above. Unlike the example embodiment described with reference to FIG. 24, a second sub-readout operation SRD2 may be executed in the same scheme as a second main readout operation MRD2 in the example embodiment illustrated in FIG. 29.

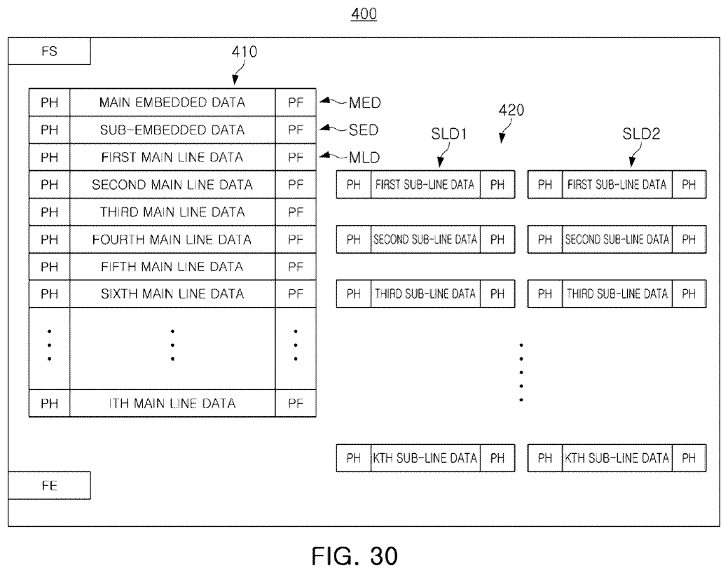

FIG. 30 is a diagram illustrating operations of an interface circuit included in an image sensor device according to an example embodiment.

FIG. 30 is a diagram illustrating the frame structure of image data 400 output by the interface circuit included in the image sensor device. The image data 400 may include main data 410 and sub-data 420. The interface circuit may transmit the main data 410 and the sub-data 420 generated by the signal processor to an external device, and may operate according to a MIPI interface, for example. The main data 410 and the sub-data 420 may be transmitted through different virtual channels.

The frame structure of the image data 400 described with reference to FIG. 30 may be similar to the frame structure of the image data 200 described with reference to FIG. 26. However, in the example embodiment described with reference to FIG. 30, the first sub-pixel signal generated by the first sub-readout operation and the second sub-pixel signal generated by the second sub-readout operation may not be merged in the signal processor. Referring to FIG. 30, after the second main line data is output, a pair of first the pieces of sub-line data SLD1 and SLD2 corresponding to the first sub-pixel signal and the second sub-pixel signal may be output in sequence.

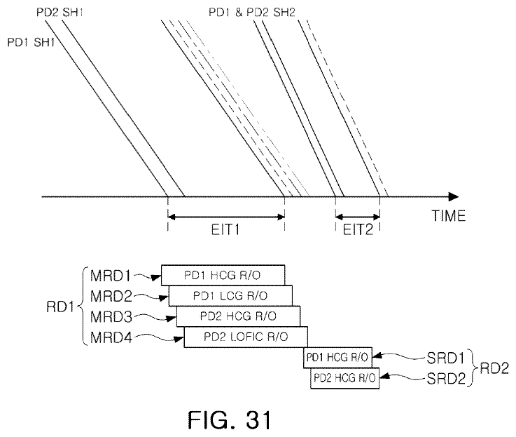

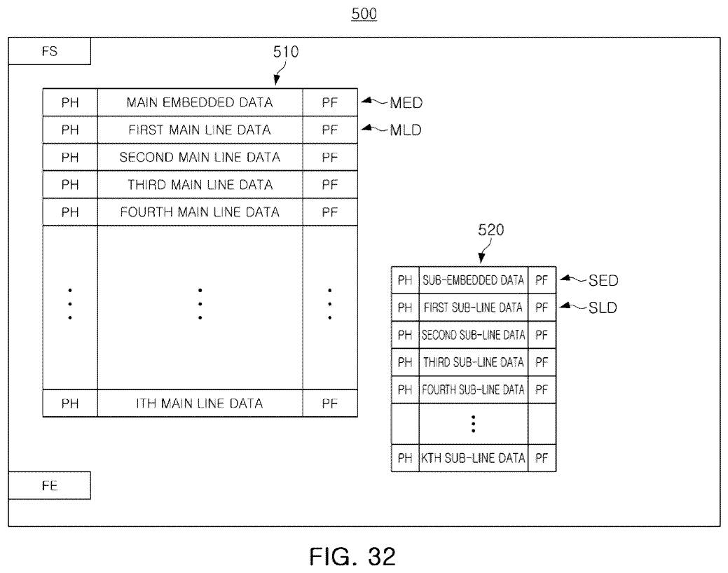

FIGS. 31 and 32 are diagrams illustrating operations of an image sensor device according to an example embodiment.

FIG. 31 may be a diagram illustrating a readout operation of a sensor unit included in an image sensor device. The readout operation described with reference to FIG. 31 may be similar to the readout operation described with reference to FIG. 24. However, in the example embodiment illustrated in FIG. 31, the sensor unit may execute a second shutter operation SH2, a second exposure time EIT2 and a second readout operation RD2 while applying analog binning to two or more pixels. Accordingly, a time difference between the first shutter operation SH1 and the second shutter operation SH2 may appear differently depending on the position of a row line. Also, the number of row lines determining the execution order of the second shutter operation SH2, the second exposure time EIT2 and the second readout operation RD2 may be smaller than the number of row lines determining the execution order of the first shutter operation SH1, the first exposure time EIT1 and the first readout operation RD1.

FIG. 32 may be a diagram illustrating a frame structure of image data 500 including main data 510 and sub-data 520 generated as a result of the readout operation described with reference to FIG. 31. The image data 500 may be transmitted to an external device by the interface circuit.

Referring to FIG. 32, the interface circuit may output a packet FS indicating the start of a frame, and main embedded data MED and a portion of the pieces of main line data MLD. As in the example described with reference to FIG. 31, a difference between the time point of execution of the first shutter operation SH1 and the time point of execution of the second shutter operation SH2 in a portion of row lines may increase due to analog binning. Accordingly, only a portion of the pieces of main line data MLD may be output in synchronization with the horizontal period after the packet FS indicating the start of a frame is output. However, the remaining pieces of main line data MLD may share horizontal periods with the pieces of sub-line data SLD. Since analog binning is applied to the readout operation, blank data may not be inserted between the pieces of sub-line data SLD.

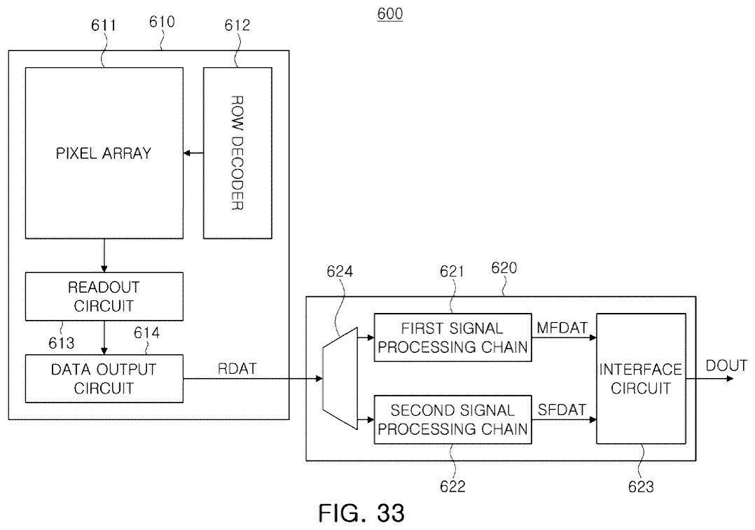

FIGS. 33 to 35 are diagrams illustrating operations of an image sensor device according to an example embodiment.

Referring to FIG. 33, an image sensor device 600 according to an example embodiment may include a sensor unit 610 and a processor 620. The sensor unit 610 may include a pixel array 611, a row decoder 612, a readout circuit 613, and a data output circuit 614, and the processor 620 may include signal processing chains 621, 622, an interface circuit 623, and a selector 624.

While the row decoder 612 drives pixels of the pixel array 611, the readout circuit 613 may execute a readout operation and may obtain a first pixel signal and a second pixel signal. For example, the first pixel signal may be a pixel signal obtained by the readout circuit 613 in the first readout operation executed after the first exposure time, and the second pixel signal may be a pixel signal obtained by the readout circuit 613 in the second readout operation executed after the second exposure time, shorter than the first exposure time.

As described above in the example, the first pixel signal may include a plurality of main pixel signals obtained under different operation conditions from the first and second photodiodes having different light-receiving areas. The second pixel signal may also include a plurality of sub-pixel signals obtained under different operation conditions. The data output circuit 614 may transmit a raw data RDAT including the first pixel signal or the second pixel signal to the processor 620.

The raw data RDAT may be processed in the first signal processing chain 621 or the second signal processing chain 622 by the selector 624 of the processor 620. For example, the first signal processing chain 621 and the second signal processing chain 622 may be provided by the signal processor. For example, the first signal processing chain 621 and the second signal processing chain 622 may be implemented by the signal processor. The raw data RDAT processed by the first signal processing chain 621 may be converted into the main data MFDAT, and the raw data RDAT processed by the second signal processing chain 622 may be converted into the sub-data SFDAT. The interface circuit 623 may transmit the output data DOUT including the main data MFDAT and the sub-data SFDAT to an external device.

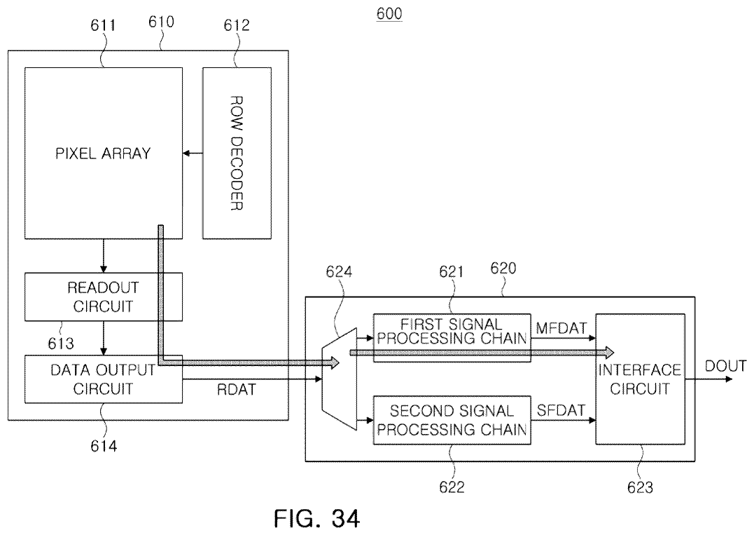

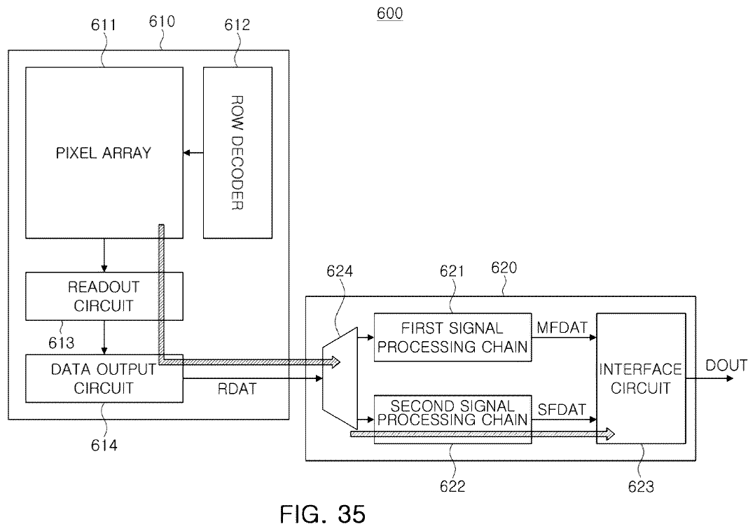

As illustrated in FIG. 34, the first pixel signal may be input to the first signal processing chain 621, and as illustrated in FIG. 35, the second pixel signal may be input to the second signal processing chain 622. In an example embodiment, the first signal processing chain 621 and the second signal processing chain 622 may commonly include a digital gain control process, a crop process, a merging process, and a binning process.

In an example embodiment, the second signal processing chain 622 may not include a bad pixel correction process, a denoise processor, a scaling process, differently from the first signal processing chain 621. The binning process applied to the first signal processing chain 621 may be different from the binning process applied to the second signal processing chain 622. For example, a sub-data SFDAT having resolution lower than resolution of the main data MFDAT may be generated by the digital binning process of the second signal processing chain 622.

The output data DOUT transmitted by the interface circuit 624 to an external device may be image data including the main data MFDAT and the sub-data SFDAT. The format of the output data DOUT may be the same as one of the example embodiments described with reference to FIGS. 26, 27, 30 and 32. The interface circuit 624 may synchronize main data MFDAT and sub-data SFDAT with a predetermined horizontal period and may output the data as line units.

According to the aforementioned example embodiments, an image sensor device may obtain a first pixel signal by executing a first readout operation after a first exposure time, and may obtain a second pixel signal by executing a second readout operation after a second exposure time shorter than the first exposure time. A signal processor of the image sensor device may generate main data by processing the first pixel signal, may generate sub-data by processing the second pixel signal, and may determine a method of outputting the main data and the sub-data based on a method of controlling the first readout operation and the second readout operation. Accordingly, the main data and the sub-data may be generated and output in a manner optimized for the operation circumstance of the image sensor device and the application to which the image sensor device is applied, and image data having an optimized dynamic range, a signal-to-noise ratio, and a frame rate may be generated.

While the example embodiments have been illustrated and described above, it will be configured as apparent to those skilled in the art that modifications and variations could be made without departing from the scope of the disclosure as defined by the appended claims.

What is claimed is:

1. An image sensor device, comprising:
a sensor comprising a plurality of pixels, and a peripheral circuit configured to drive the plurality of pixels; and
a processor comprising a signal processor configured to obtain image data by processing a pixel signal output by the peripheral circuit, and an interface circuit configured to transmit the image data to an external device,
wherein each of the plurality of pixels comprises a first photodiode having a first light-receiving area, a second photodiode having a second light-receiving area smaller than the first light-receiving area, and a pixel circuit connecting the first photodiode and the second photodiode to the peripheral circuit,
wherein the peripheral circuit is further configured to obtain a first pixel signal by executing a first readout operation for the plurality of pixels after a first exposure time, and obtain a second pixel signal by executing a second readout operation different from the first readout operation for at least a portion of pixels among the plurality of pixels after a second exposure time shorter than the first exposure time,
wherein the signal processor is further configured to obtain first data by processing the first pixel signal and obtain second data by processing the second pixel signal, and
wherein the interface circuit is configured to start transmission of the second data before transmission of the first data is completed.

2. The image sensor device of claim 1,
wherein the pixel circuit comprises:
a floating diffusion node,
a first transfer transistor connected between the floating diffusion node and the first photodiode,
a second transfer transistor connected between the floating diffusion node and the second photodiode, and
a gain control transistor connected to the floating diffusion node, and
wherein the peripheral circuit is configured to select a high conversion gain state by turning off the gain control transistor and to select a low conversion gain state by turning on the gain control transistor.

3. The image sensor device of claim 2,
wherein, in the first readout operation, each of the plurality of pixels is configured to:
output a voltage corresponding to electric charge generated by the first photodiode in sequence under a high conversion gain state and a low conversion gain state,
output a voltage corresponding to electric charge generated by the second photodiode under a high conversion gain state, and
output a voltage corresponding to electric charge generated by the second photodiode and stored in a capacitor of the pixel circuit.

4. The image sensor device of claim 3, wherein, in the second readout operation, each of the at least the portion of the plurality of pixels is configured to:
output a voltage corresponding to electric charge generated by the first photodiode under a low conversion gain state, and
output a voltage corresponding to electric charge generated by the second photodiode under a high conversion gain state.

5. The image sensor device of claim 3, wherein, in the second readout operation, each of the at least the portion of the plurality of pixels is configured to output a voltage corresponding to electric charge generated by the first photodiode under a high conversion gain state and a low conversion gain state in sequence.

6. The image sensor device of claim 1,
wherein the plurality of pixels is arranged along a plurality of row lines and a plurality of column lines,
wherein the first data comprises a plurality of main line data corresponding to the plurality of row lines, and the second data comprises a plurality of sub-line data corresponding to at least a portion of the plurality of row lines, and
wherein the interface circuit is further configured to:
transmit a plurality of main line data groups including N number of main line data among the plurality of main line data in sequence, and
transmit a plurality of sub-line data groups including M number of main line data among the plurality of sub-line data in sequence,
where N is a natural number equal to or greater than 2, and M is a natural number less than N.

7. The image sensor device of claim 6, wherein the interface circuit is further configured to alternately transmit the plurality of main line data groups and the plurality of sub-line data groups.

8. The image sensor device of claim 7, wherein the interface circuit is further configured to:
transmit a first portion of the plurality of main line data groups consecutively, and
alternately transmit a second portion of the plurality of main line data groups and the plurality of sub-line data groups.

9. The image sensor device of claim 8, wherein the interface circuit is further configured to:
complete transmission of the plurality of main line data groups. and
after completion of transmission of the plurality of main line data groups, transmit a portion of the plurality of sub-line data groups consecutively.

10. The image sensor device of claim 1,
wherein the plurality of pixels is arranged along a plurality of row lines and a plurality of column lines, and
wherein while the peripheral circuit executes the first readout operation for each pixel connected to a first row line among the plurality of row lines, the peripheral circuit is further configured to execute a shutter operation for each pixel connected to a second row line, different from the first row line.

11. The image sensor device of claim 10, wherein the peripheral circuit is further configured to complete the shutter operation for each pixel connected to the second row line and executes an exposure operation during the second exposure time.

12. The image sensor device of claim 1,
wherein the signal processor comprises a first signal processing chain and a second signal processing chain different from the first signal processing chain, and
wherein the signal processor is further configured to:
obtain the first data by processing the first pixel signal according to the first signal processing chain, and
obtain the second by processing the second pixel signal according to the second signal processing chain.

13. The image sensor device of claim 1,
wherein the plurality of pixels is arranged along a plurality of row lines and a plurality of column lines, and
wherein the sensor is further configured to:
execute the first readout operation for a first portion of pixels arranged along a first row line among the plurality of row lines, and
execute the second readout operation for a second portion of pixels arranged along a second row line, different from the first row line, during a single horizontal period.

14. An image sensor device, comprising:
a plurality of pixels arranged along a plurality of row lines and a plurality of column lines, each of the plurality of pixels comprising a first photodiode having a first light-receiving area, a second photodiode having a second light-receiving area smaller than the first light-receiving area, and a pixel circuit connected to the first photodiode and the second photodiode;
a peripheral circuit configured to execute a first shutter operation, a first exposure operation for a first time, a first readout operation, a second shutter operation, a second exposure operation for a second time shorter than the first time, and a second readout operation for the plurality of pixels in sequence; and
a signal processor configured to obtain image data by processing a pixel signal output by the peripheral circuit,
wherein the peripheral circuit, while executing the first readout operation for each of first pixels arranged along a first row line among the plurality of row lines, is further configured to execute the second shutter operation for the first photodiode and the second photodiode included in each of second pixels arranged along a second row line different from the first row line.

15. The image sensor device of claim 14, wherein, in at least one horizontal period, the peripheral circuit is further configured to:
execute the first readout operation for each of pixels arranged along one row line among the plurality of row lines, and
execute the second readout operation for each of pixels arranged along another row line, different from the one row line.

16. The image sensor device of claim 14,
wherein the first readout operation comprises a plurality of main readout operations executed in sequence, and the second readout operation comprises a plurality of sub-readout operations executed in sequence, and
wherein a number of the plurality of main readout operations is equal to a number of the plurality of sub-readout operations.

17. The image sensor device of claim 14,
wherein the first readout operation comprises a plurality of main readout operations executed in sequence, and the second readout operation comprises a plurality of sub-readout operations executed in sequence, and
wherein a number of the plurality of main readout operations is greater than a number of the plurality of sub-readout operations.

18. An image sensor device, comprising:
a sensor comprising a plurality of pixels, and a peripheral circuit configured to execute a first shutter operation, a first exposure operation, a first readout operation, a second shutter operation, a second exposure operation and a second readout operation in sequence for the plurality of pixels; and
a processor comprising:
a signal processor configured to obtain first data by processing a first pixel signal obtained by the first readout operation by the peripheral circuit, and obtain second data by processing a second pixel signal obtained by the second readout operation by the peripheral circuit, and
an interface circuit configured to transmit the first data and the second data to an external device,
wherein the first data has a first resolution and the second data has a second resolution lower than the first resolution, and
wherein the interface circuit is further configured to alternately transmit at least a portion of a plurality of first line data included in the first data and at least a portion of a plurality of second line data included in the second data.

19. The image sensor device of claim 18, wherein the interface circuit is further configured to:
transmit the first data and the second data line by line in synchronization with a horizontal period, and
transmit one of the plurality of first line data and one of the plurality of second line data in at least one horizontal period in sequence.

20. The image sensor device of claim 18, wherein a number of the plurality of first line data is greater than a number of the plurality of second line data.
